(19) United States
(12) Patent Application Publication
(10) Pub. No.: US 2026/0334667 A1
(43) Pub. Date: Oct. 29, 2026

(54) LIFT MECHANISM WITH SELECTABLE LIFT FORCE RANGES

(71) Applicant: Ergotron, Inc., st. Paul, MN (US)

(72) Inventors: Nicholas Robert Swartz, St. PAul, MN (US); Mustafa A. Ergun, Eden Prairie, MN (US); Jonathan Northcutt Dunn, Maple Grove, MN (US); Michael P. Barros, Minnetonka, MN (US); Jeffrey Randall Mensing, Eden Prairie, MN (US)

(21) Appl. No.: 19/123,369

(22) PCT Filed: Sep. 29, 2023
(86) PCT No.: PCT/US2023/034189

§ 371 Date: Apr. 22, 2025

Related U.S. Application Data
(60) Provisional application No. 63/381,704, filed on Oct. 31, 2022.

(51) Int. Cl. A47B 9/02; A47B 21/02; F16M 11/04; F16M 11/42

(52) U.S. Cl. CPC A47B 9/02; F16M 11/046; A47B 21/02; F16M 11/42; F16M 2200/047

(57) ABSTRACT

A lift mechanism can be designed for raising and lowering a component. The lift mechanism can include a movable bracket in sliding engagement with a support column. The lift mechanism can also include a counterbalance mechanism having one or more springs, an adjustment assembly, and a wheel assembly. The lift mechanism can be configured to translate the component coupled to the movable bracket relative to the support column. The counterbalance mechanism can be operably coupled between the support column and the movable bracket. As the movable bracket translates relative to the support column, the counterbalance mechanism can generate a lift force to offset the weight of the component. The counterbalance mechanism can also include an anchor. The anchor can be selectively coupled to the support column or the movable bracket to put the lift mechanism in one of a high force orientation or a low force orientation, respectively.

### CLAIM OF PRIORITY

This patent application claims the benefit of priority of Swartz, et al. U.S. Provisional Patent Application Ser. No. 63/381,704, entitled “LIFT MECHANISM WITH SELECTABLE LIFT FORCE RANGES,” filed on Oct. 31, 2022 (Attorney Docket No 5983.476PRV), which is hereby incorporated by reference herein in its entirety.

### TECHNICAL FIELD

This document pertains generally, but not by way of limitation, to a lift mechanism for lifting and counterbalancing a load.

### BACKGROUND

Electronic displays, such as, for example, computer monitors, tablets, televisions, or the like, and workstations, such as, for example, desks, carts, wall mounts, or the like, are used in a variety of settings. In some settings, one electronic display may be used by multiple operators. In another example, a television may be deployed in a conference center where many individuals use the electronic display throughout the day. In yet another example, a workstation may be deployed in a workplace that is shared by multiple employees. It can be appreciated that differences in people's size and preferences may call for a shared electronic display or a shared workstation to be adjustable to accommodate the individual preferences of the users, such as, for example sitting or standing elbow height, sitting or standing eye height, or the like. In other settings, an electronic display or a workstation that is dedicated to an individual user may also need to be adjusted. For example, a single user may have physical requirements or a preference to periodically sit and stand while using an electronic display or a workstation. In these situations, a height adjustment mechanism may be used to accommodate the needs of the multiple operators or the single user. Ease of height adjustment as well as accurate settings of the lift mechanism, for example, setting of the lift force to closely match the weight of the electronic display or the moving components of a workstation, may be important considerations for a user.

### BRIEF DESCRIPTION OF THE DRAWINGS

The following drawings are illustrative of particular embodiments of the present invention and therefore do not limit the scope of the invention.

The drawings are not to scale and are intended for use in conjunction with the explanations in the following detailed description. Like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram representation of a positioning apparatus according to an example configuration of the current disclosure.

FIG. 2 is a perspective view of a mobile workstation according to an example configuration of the current disclosure.

FIG. 3 is a perspective view of a wall mounted workstation according to an example configuration of the current disclosure.

FIG. 4 is a perspective view of a mobile media center according to an example configuration of the current disclosure.

FIG. 5 is a perspective view of a wall mount for an electronic display according to an example configuration of the current disclosure.

FIG. 6 is a side view of the wall mount of FIG. 5.

FIG. 7 is a schematic view of a lift mechanism according to an example configuration of the current disclosure.

FIG. 8 is a schematic view of a lift mechanism according to another example configuration of current disclosure.

FIG. 9A is a schematic view of the lift mechanism of FIG. 7 in a low position. The lift mechanism is shown in a low force orientation.

FIG. 9B is an enlarged partial schematic view of the lift mechanism of FIG. 9A.

FIG. 10A is a schematic view of the lift mechanism of FIG. 7 in a low position. The lift mechanism is shown in a high force orientation.

FIG. 10B is an enlarged partial schematic view of the lift mechanism of FIG. 10A.

FIG. 11 is a perspective view of the lift mechanism according to an example configuration of the current disclosure.

FIG. 12 is a front view of the lift mechanism of FIG. 11 in a high position.

FIG. 13 is a front view of the lift mechanism of FIG. 11 in a high position.

FIG. 14 is a front view of the lift mechanism of FIG. 11 in a low position. The lift mechanism is shown in a high force orientation.

FIG. 15 is a front view of the lift mechanism of FIG. 11 in a low position. The lift mechanism is shown in a low force orientation.

FIG. 16 is a schematic view of a lift mechanism according to yet another example configuration of the current disclosure.

FIG. 17 is a schematic view of the lift mechanism of FIG. 7 according to an example configuration of the current disclosure.

FIG. 18 is a schematic view of the lift mechanism of FIG. 17 in a high force orientation.

FIG. 19 is a schematic view of the lift mechanism of FIG. 17 in a low force orientation.

FIG. 20 is a schematic view of a glider interface with the anchor of FIG. 16 according to an example configuration of the current disclosure.

FIG. 21 is a schematic view of the glider interface of FIG. 20.

FIG. 22 is partial perspective view of a lift mechanism according to an example configuration of the current disclosure.

FIG. 23 is a perspective view of an interface between an anchor and a glider according to an example configuration of the current disclosure.

FIG. 24 is a partial schematic view of a lift mechanism according to an example configuration of the current disclosure.

FIG. 25 is a schematic view of the block of FIG. 24.

FIG. 26 is a schematic view of the pin of FIG. 24.

FIG. 27 is a perspective view of a lift mechanism according to an example configuration of the current disclosure.

FIG. 28 is a perspective view of an anchor of FIG. 27.

FIG. 29 is a perspective view of the coupler mechanism of FIG. 27.

FIG. 30 is a partial perspective view of the lift mechanism of FIG. 27. The coupler mechanism is shown in a decoupled configuration.

FIG. 31 is a partial perspective view of the lift mechanism of FIG. 27. The coupler mechanism is shown in a coupled configuration.

### OVERVIEW

This disclosure is directed to a positioning apparatus that can move a component (e.g., an electronic display, a work surface, a platform, or the like) along a range of travel. In some example configurations, the positioning apparatus can include a lift mechanism. The lift mechanism can include a fixed portion and a movable portion, and it can be coupled to a structure. The fixed portion can be stationary relative to the structure and the movable portion can translate relative to the fixed portion. The component can be coupled to the movable portion. The lift mechanism can be configured to raise and lower the component relative to the structure.

The lift mechanism can also include a counterbalance mechanism. The counterbalance mechanism can be coupled between the fixed portion and the movable portion. The counterbalance mechanism can be configured to generate a lift force for countering the weight of the component coupled to the movable portion (e.g., the weight of the electronic display, the weight of the work surface, or the like). In some example configurations, the lift force can be adjusted (e.g., increased or decreased) between a high force (e.g., maximum lift force) and a low force (e.g., minimum lift force) to closely match the weight of the component coupled to the movable portion.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

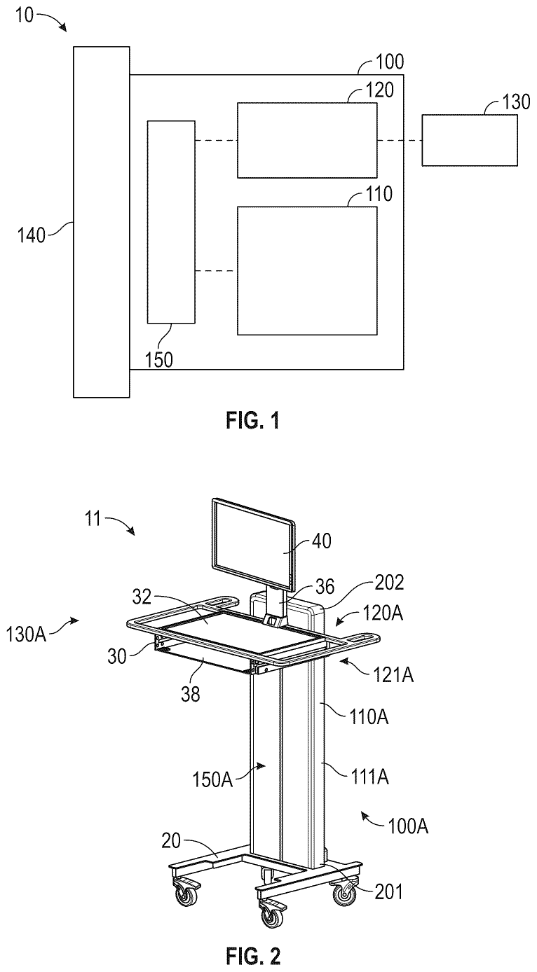

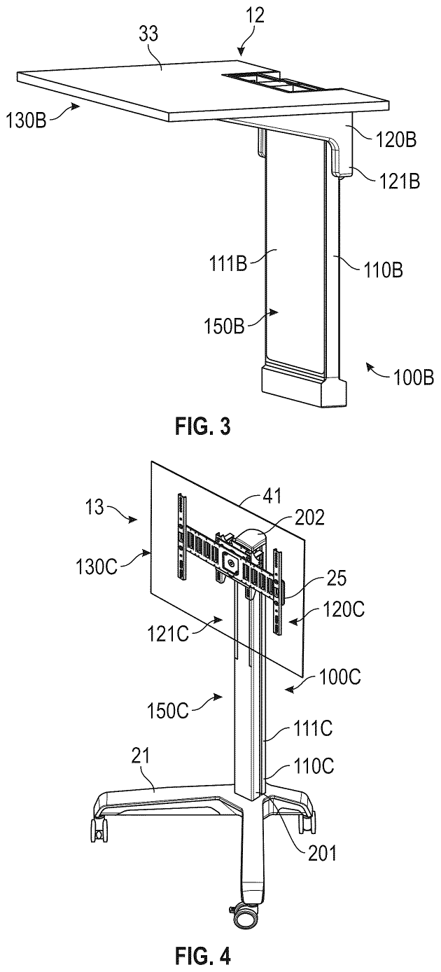

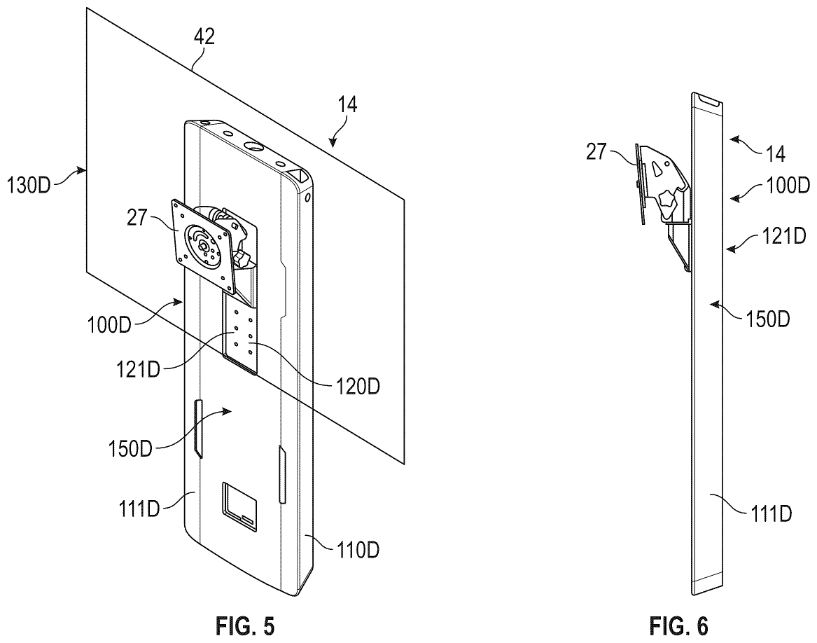

FIG. 1 is a block diagram representation of a positioning apparatus 10 according to some example configurations of the current disclosure. The positioning apparatus 10 can be one of a mobile workstation 11 (shown in FIG. 2), a wall mounted workstation 12 (shown in FIG. 3), a mobile media center 13 (shown in FIG. 4), a wall mount assembly 14 (shown in FIG. 5), or the like. The positioning apparatus 10 can include a lift mechanism 100. The lift mechanism 100 can be coupled to a structure 140 including, but not limited to a wall, a wheeled base, cabinet, or the like.

The lift mechanism 100 can include a fixed portion 110 and a movable portion 120. The fixed portion 110 can be stationary relative to the structure 140. The movable portion 120 can be slidingly coupled to the fixed portion 110. A component 130 (e.g., an electronic display, a work surface, a platform, or the like) can be coupled to the movable portion 120. The lift mechanism 100 can be configured to raise and lower the component 130 relative to the structure 140. In some example configurations, one or more components can be coupled to the movable portion 120. The lift mechanism 100 can be configured to raise and lower the one or more components relative to the structure 140.

The lift mechanism 100 can also include a counterbalance mechanism 150 coupled to the fixed portion 110 and the movable portion 120. The counterbalance mechanism 150 can be adapted to counter a portion of the weight of the component 130.

FIGS. 2-6 illustrate various applications of a positioning apparatus according to some example configurations of the current disclosure. As it will be apparent in the following sections, each of the example configurations shown in FIGS. 2-6 can include all the components of the lift mechanism 100 of FIG. 1 in various forms. In some example configurations, the movable portion 120 of the lift mechanism 100 can be provided in the form of a movable bracket (e.g., the movable bracket 121A of FIG. 2), and the fixed portion 110 of the lift mechanism 100 can be provided in the form of a support column (e.g., the support column 111A of FIG. 2).

FIG. 2 is a perspective view of a mobile workstation 11 according to an example configuration of the current disclosure. The mobile workstation 11 can include a lift mechanism 100A having a fixed portion 110A (e.g., a support column 111A) and a movable portion 120A (e.g., a movable bracket 121A). The movable bracket 121A can be slidingly coupled to the support column 111A. The support column 111A can be coupled to a wheeled base 20 at its first section 201 and coupled to the movable bracket 121A proximate its second section 202. A component 130A (e.g., a platform 30, or the like) can be coupled to the movable bracket 121A. The platform 30 can include a work surface 32, a display mount 36, a keyboard tray 38, and one or more other electronic components. The display mount 36 can hold an electronic display 40 above the work surface 32. The lift mechanism 100A can be configured to raise and lower the component 130A (e.g., the platform 30 and other components coupled to the platform 30).

The lift mechanism 100A of the mobile workstation 11 of FIG. 2 can also include a counterbalance mechanism 150A. The counterbalance mechanism 150A can be located inside the support column 111A. The counterbalance mechanism 150A can be coupled between the support column 111A and the movable bracket 121A. The counterbalance mechanism 150A can generate a lift force for countering a combined weight of the component 130A (e.g., a weight of the platform 30, the display mount 36, the electronic display 40, or the like) and a portion of the lift mechanism 100A (e.g., a weight of the movable bracket 121A, or the like).

FIG. 3 is a perspective view of a wall mounted workstation 12 according to an example configuration of the current disclosure. The wall mounted workstation 12 can include a lift mechanism 100B having a fixed portion 110B (e.g., a support column 111B) and a movable portion 120B (e.g., a movable bracket 121B). The movable bracket 121B can be slidingly coupled to the support column 111B. The support column 111B can be coupled to a wall. A component 130B (e.g., a work surface 33, or the like) can be coupled to the movable bracket 121B. The lift mechanism 100B can be configured to raise and lower the component 130B.

The lift mechanism 100B of the wall mounted workstation 12 of FIG. 3 can also include a counterbalance mechanism 150B. The counterbalance mechanism 150B can be located inside the support column 111B. The counterbalance mechanism 150B can be coupled between the support column 111B and the movable bracket 121B. The counterbalance mechanism 150B can generate a lift force for countering a combined weight of the component 130B (e.g., a weight of the work surface 33, or the like) and a portion of the lift mechanism 100B (e.g., a weight of the movable bracket 121B, or the like).

FIG. 4 is a perspective view of a mobile media center 13 according to an example configuration of the current disclosure. The mobile media center 13 can include a lift mechanism 100C having a fixed portion 110C (e.g., a support column 111C) and a movable portion 120C (e.g., a movable bracket 121C). The movable bracket 121C can be slidingly coupled to the support column 111C. The support column 111C can be coupled to a wheeled base 21 at a first section 201 and coupled to the movable bracket 121C proximate a second section 202. A display mounting bracket assembly 25 can be coupled to the movable bracket 121C. A component 130C (e.g., an interactive display 41, a TV, or the like) can be coupled to the display mounting bracket assembly 25. The interactive display 41 is rendered transparent for clarity in FIG. 4. The lift mechanism 100C can be configured to raise and lower the component 130C.

The lift mechanism of the mobile media center 13 of FIG. 4 can also include a counterbalance mechanism 150C. The counterbalance mechanism 150C can be located inside the support column 111C. The counterbalance mechanism 150C can be coupled between the support column 111C and the movable bracket 121C. The counterbalance mechanism 150C can generate a lift force for countering the weight of the component 130C (e.g., a weight of the electronic display, or the like) and a portion of the lift mechanism 100C (e.g., a weight of the movable bracket 121C, a weight of the display mounting bracket assembly 25, or the like).

FIGS. 5-6 are a perspective view and a side view of a wall mount assembly 14, respectively, according to an example configuration of the current disclosure. The wall mount assembly 14 can be configured to mount an electronic display on a wall. The wall mount assembly 14 can include a lift mechanism 100D having a fixed portion 110D (e.g., a support column 111D) and a movable portion 120D (e.g., a movable bracket 121D). The support column 111D can be coupled to a wall and the movable bracket 121D can be slidingly coupled to the support column 111D. A display interface 27 can be coupled to the movable bracket 121D. A component 130D (e.g., an electronic display 42, or the like) can be coupled to the display interface 27. The electronic display 42 is rendered transparent for clarity in FIG. 5. The lift mechanism 100D can be configured to raise and lower the component 130D relative to the wall.

The lift mechanism 100D of the wall mount assembly 14 of FIGS. 5-6 can also include a counterbalance mechanism 150D. The counterbalance mechanism 150D can be located inside the support column 111D. The counterbalance mechanism 150D can be coupled between the support column 111D and the movable bracket 121D. The counterbalance mechanism 150D can generate a lift force for countering combined weight of the component 130D (e.g., the electronic display, or the like) and a portion of the lift mechanism 100D (e.g., weight of the movable bracket 121D, or the like).

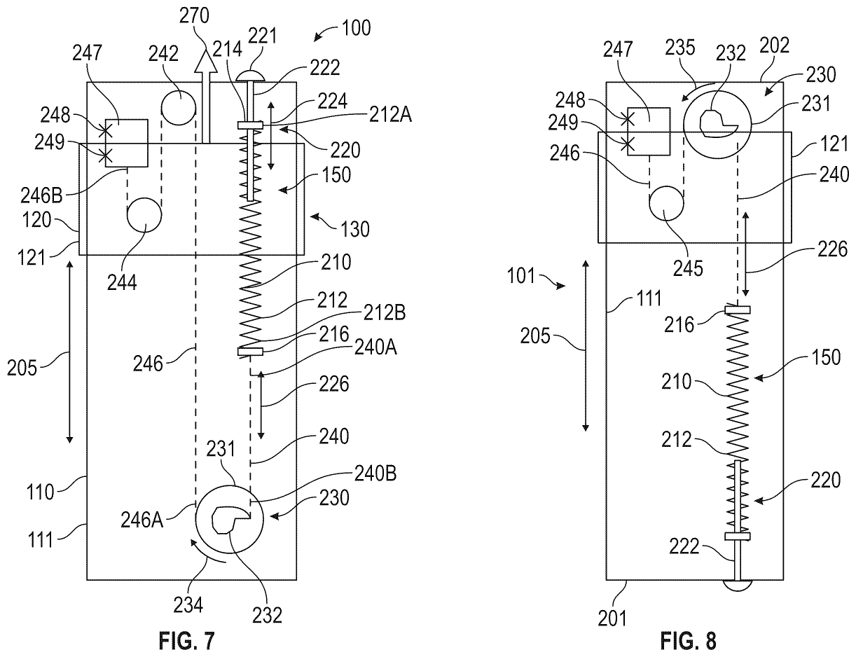

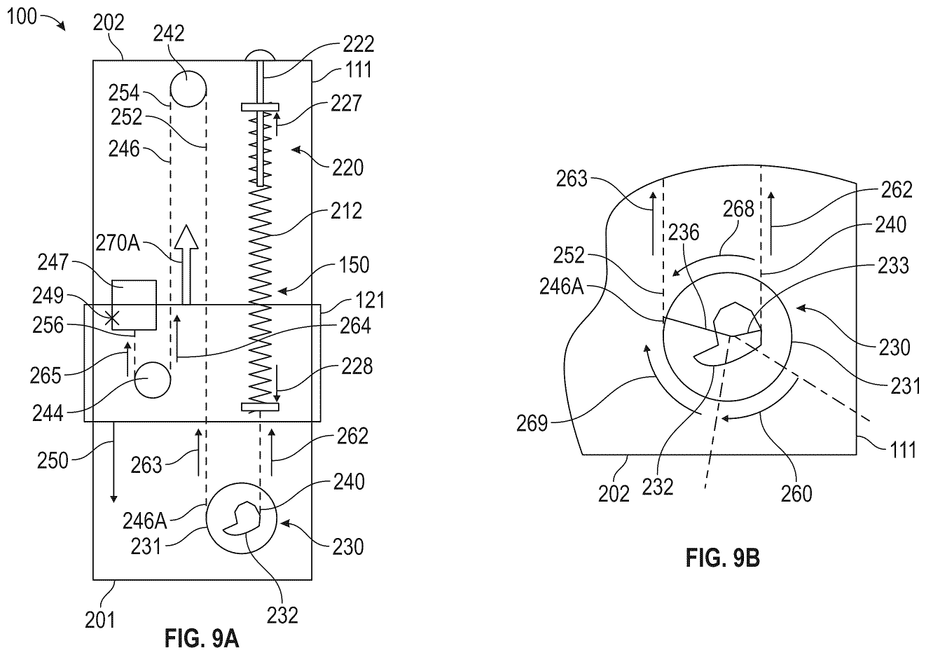

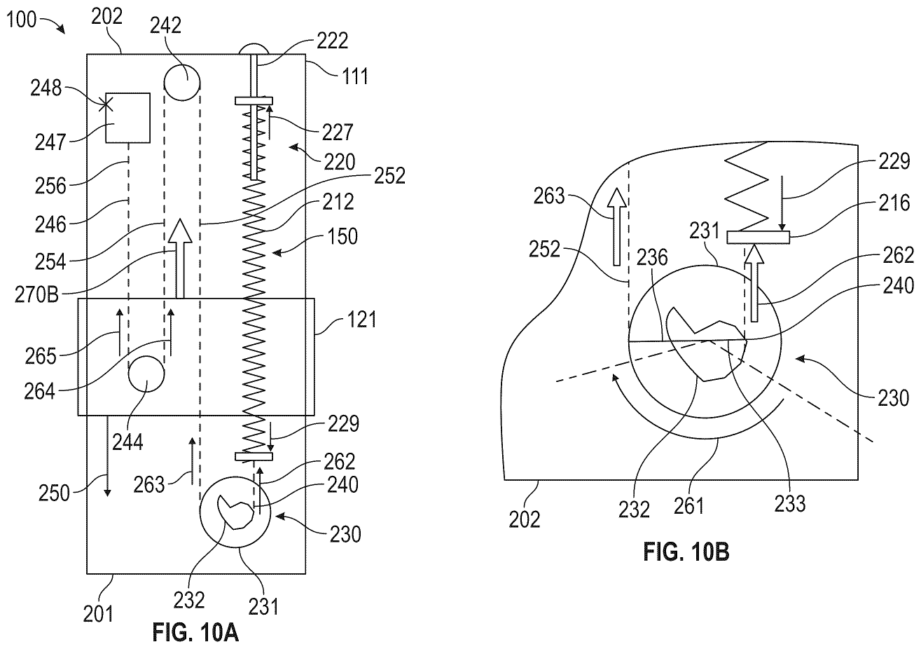

It can be appreciated that the component 130 (e.g., the platform, the electronic display, the work surface, or the like) coupled to the movable portion 120 can have wide range of weights. The range of weights can depend on the make and model of the equipment (e.g., the electronic display, or the like), the manufacturing material (e.g., material of the work surface, the platform, or the like) and other factors. In some example configurations, the force generated by the lift mechanism 100 can be adjustable to accommodate for wide range of weights. An adjustment of the lift force can be done in two stages. In the first stage, the user of the positioning apparatus can set the lift force range in one of a high force orientation, as illustrated in FIG. 10A, or a low force orientation, as illustrated in FIG. 9A. In the second stage, the lift force can also be adjusted in each of the high force orientation and the low force orientation by adjusting a tension of an energy storage member (e.g., one or more springs) included in the counterbalance mechanism (shown in FIG. 7).

FIG. 7 is a schematic view of a typical lift mechanism 100 according to an example configuration of the current disclosure. One or more portions of the lift mechanism 100 are rendered transparent for clarity. The lift mechanism 100 can include fixed portion 110 (e.g., a support column 111) and a movable portion 120 (e.g., a movable bracket 121) movably coupled to the fixed portion 110. The support column 111 can be elongated between a second section 202 and a first section 201. The movable bracket 121 can be configured to translate at least a portion of the support column 111 through a range of travel 205.

The support column 111 can be configured to be coupled (e.g., directly, or indirectly) to a structure 140 (e.g., a wall, a wheeled base, or the like), and a component 130 (e.g., an electronic display, a platform, a work surface, or the like) can be coupled (e.g., directly, or indirectly) to the movable bracket 121. In some example configurations, a positioning apparatus 10 (e.g., the wall mount assembly 14 of FIGS. 5-6) including the lift mechanism 100 (e.g., the lift mechanism 100D) can translate an electronic display relative to the structure 140 (e.g., a wall) by translating the movable bracket 121 (e.g., the movable bracket 121D) relative to the support column 111 (e.g., the support column 111D). In other example configurations, a positioning apparatus 10 (e.g., the mobile workstation 11 of FIG. 2) including the lift mechanism 100 (e.g., the lift mechanism 100A) can translate a work surface (e.g., the work surface 32) relative to the structure 140 (e.g., the wheeled base 20) by translating the movable bracket 121 (e.g., the movable bracket 121A) relative to the support column 111 (e.g., the support column 111A). In each of these example configurations, the movable bracket 121 can be configured to translate between a high position (e.g., proximate the second section 202 of the support column 111) and a low position (e.g., proximate the first section 201 of the support column 111).

In some example configurations, the lift mechanism 100 can include a counterbalance mechanism 150. The counterbalance mechanism 150 can be operatively coupled between the support column 111 and movable bracket 121. The counterbalance mechanism 150 can generate a lift force 270 for countering at least a portion of the combined weight coupled to the movable bracket 121 (e.g., combined weight of the component 130 and the weight of the movable bracket 121).

The counterbalance mechanism 150 can include an energy storage member 210, an adjustment assembly 220, and a wheel assembly 230. The energy storage member 210 can include one or more springs 212 (e.g., including one or more extension springs, a compression spring, a leaf spring, a torsion soring, or the like). A first spring plate 214 can be coupled to a first portion 212A of the one or more springs 212 and a second spring plate 216 can be coupled to a second portion 212B of the one or more springs 212.

The first spring plate 214 can be threadedly engaged with an adjustment screw 222 where the adjustment screw 222 can be rotatably coupled to the support column 111 (e.g., coupled to the support column 111 proximate the second section 202, as illustrated in FIG. 7). The adjustment screw 222 can be configured to translate the first spring plate 214 along a portion of its length. As the adjustment screw 222 is rotated, the first spring plate 214 can translate along an axial direction of the adjustment screw 222 through a range of adjustment 224.

The adjustment assembly 220 can deflect (e.g., pull or push) the first portion 212A of the one or more springs 212 to adjust a pre-tension of the one or more springs 212. For example, a first deflection 227 (e.g., a pull shown in FIG. 9A) to adjust (e.g., increase) a pre-tension of the one or more springs 212. In general, the pre-tension of the one or more springs 212 can be adjusted when the movable bracket 121 is stationary relative to the support column 111 (e.g., when the movable bracket 121 is stationary at the high position).

The one or more springs 212 can be operationally coupled to the wheel assembly 230 via the second spring plate 216 and a first tensile member 240. The second spring plate 216 can translate as the movable bracket 121 translates relative to the support column 111. The second spring plate 216 can be configured to deflect (e.g., pull) the second portion 212B of the one or more springs 212 through a range of deflection 226 (e.g., a second deflection 228 shown in FIG. 9A).

The wheel assembly 230 can include a wheel member 231 and a cam member 232. The wheel assembly 230 can be rotatably coupled to the support column 111 proximate the first section 201. The cam member 232 can be fixedly attached to the wheel member 231. In some example configurations, the cam member 232 can be formed as an integral part of the wheel member 231. The wheel member 231 and the cam member 232 can be concentric, and they can rotate in unison around an axle located at the center of the wheel member 231.

A first section 240A of the first tensile member 240 can be coupled to the second spring plate 216, and a second section 240B of the first tensile member 240 can be coupled to the cam member 232. The first tensile member 240 can be configured to wrap around the cam member 232 as the wheel assembly 230 rotates in a clockwise direction 234, as illustrated in FIG. 7. The one or more springs 212 can bias the wheel assembly 230 to rotate in a counterclockwise direction.

In some example configurations, the lift mechanism 100 can also include a first idler pulley 242 and a second idler pulley 244. The first idler pulley 242 can be rotatably coupled to the support column 111 proximate the second section 202, as illustrated in FIG. 7. The second idler pulley 244 can be rotatably coupled to the movable bracket 121. The second idler pulley 244 can move together with the movable bracket 121 as the movable bracket 121 translates through the range of travel 205.

The counterbalance mechanism 150 can be operationally coupled to the movable bracket 121 via a second tensile member 246. The second tensile member 246 can have a first section 246A and a second section 246B. The first section 246A can be coupled to the wheel member 231. The second tensile member 246 can be routed around the first idler pulley 242 and the second idler pulley 244, and the second section 246B can be coupled to an anchor 247. The movable bracket 121 can urge the wheel assembly 230 to rotate in a clockwise direction 234 as the movable bracket 121 translates relative to the support column 111 towards the first section 201.

The first section 246A of the second tensile member 246 can be wrapped around the wheel member 231 when the movable bracket 121 is at the high position (e.g., when the movable bracket 121 is located proximate the second section 202, as illustrated in FIG. 7). The second tensile member 246 can unwrap from the wheel member 231 when the wheel assembly 230 rotates in the clockwise direction 234 (e.g., when the movable bracket 121 translates towards the first section 201.

In some example configurations, the first tensile member 240 and the second tensile member 246 can be combined in a single elongated tensile member. The first tensile member, the second tensile member (or the single elongated tensile member) can be made of a material including, but not limited to, steel cable, tensile polymer cord, chain, or the like.

The anchor 247 can be configured to couple the second section 246B of the second tensile member 246 to either the support column 111 (e.g., in the high force orientation, as illustrated in FIG. 10A) or the movable bracket 121 (e.g., in the low force orientation, as illustrated in FIG. 9A). In some example configurations, a first fastener 248 can be used to couple the anchor 247 to the support column 111, and a second fastener 249 can be used to couple the anchor 247 to the movable bracket 121. A user of the positioning apparatus 10 can selectively couple the anchor 247 to the support column 111 or the movable bracket 121 using the first fastener 248 or the second fastener 249, respectively, depending on the desired force outcome (e.g., a high force orientation or a low force orientation) of the counterbalance mechanism 150. It can be appreciated that other mechanisms or methods can be used to selectively couple the anchor 147 to the support column 111 or to the movable bracket 121. Some of these mechanisms and methods are described in later sections of this disclosure.

FIG. 8 is a schematic view of a lift mechanism 101 according to another example configuration of the current disclosure. The lift mechanism 101 can have a support column 111 and a movable bracket 121. The support column 111 can extend between the second section 202 and the first section 201. The support column 111 can be coupled to a structure (e.g., a wall, a wheeled base, or the like), and the movable bracket 121 can be coupled to a component (e.g., an electronic display, a worksurface, or the like).

The lift mechanism 101 of FIG. 8 can include a counterbalance mechanism 150. The counterbalance mechanism 150 can be operationally coupled between the support column 111 and the movable bracket 121. The counterbalance mechanism 150 can be configured to counter at least a portion of the weight of the component coupled to the movable bracket 121 (e.g., weight of the display, weight of the worksurface, weight of the movable bracket, or the like). The counterbalance mechanism 150 can include an adjustment assembly 220, an energy storage member 210 (e.g., one or more springs 212), and a wheel assembly 230. The adjustment assembly 220 can be coupled to the support column 111 proximate the first section 201, and the wheel assembly 230 can be rotatably coupled to the support column 111 proximate the second section 202. The wheel assembly 230 can include a wheel member 231 and a cam member 232. The cam member 232 can be fixedly attached to the wheel member 231. The wheel member 231 and the cam member 232 can rotate in unison around a rotation axis located at the center of the wheel member 231.

The one or more springs 212 can be coupled to a first spring plate 214 on the first portion 212A and coupled to a second spring plate 216 on the second portion 212B. The first spring plate 214 can be threadedly engaged with an adjustment screw 222. A first tensile member 240 can be coupled between the second spring plate 216 and the wheel assembly 230. The adjustment screw 222 can be coupled to the support column 111 proximate the first section 201. The adjustment screw 222 can be configured to move the first spring plate 214 along at least a portion of its length to adjust a tension (e.g., a pre-tension) of the one or more springs 212.

The lift mechanism 101 of FIG. 8 can also include an idler pulley 245. The idler pulley 245 can be rotatably coupled to the movable bracket 121. A second tensile member 246 can be coupled to the wheel assembly 230 on the first section 246A, the second tensile member 246 can be routed around the idler pulley 245, and an anchor 247 can be coupled to the second section 246B of the second tensile member 246. The anchor 247 can be selectively coupled to the support column 111 or the movable bracket as discussed in previous sections.

The movable bracket 121 is configured to translate along a range of travel 205 between the second section 202 and the first section 201. The second tensile member 246 can be initially wrapped around the wheel member 231 when the movable bracket 121 is at the high position (e.g., the movable bracket 121 is proximate the second section 202 of the support column 111, as illustrated in FIG. 8). The second tensile member 246 can urge the wheel assembly 230 to rotate in a counterclockwise direction 235 as the movable bracket 121 translates along the range of travel 205 towards the first section 201. A section of the second tensile member 246 can unwrap from the wheel member 231 to allow the movable bracket to translate towards the first section 201. The first tensile member 240 can wrap around the cam member 232 as the wheel assembly 230 rotates in the counterclockwise direction 235.

FIGS. 9A-9B are schematic views of the lift mechanism 100 of FIG. 7. The movable bracket 121 can translate a first distance 250 from a high position (e.g., proximate the second section 202) towards a low position (e.g., proximate the first section 201). The movable bracket 121 is shown in a low position in FIG. 9A. The lift mechanism is shown in the low force orientation in FIG. 9A. In the low force orientation, the anchor 247 can be coupled to the movable bracket 121 using the second fastener 249 such that the anchor 247 can be adapted to translate with the movable bracket 121.

The second tensile member 246 can be coupled to the wheel member 231 on a first section 246A and coupled to the anchor 247 on a second section 246B. The second tensile member 246 can be routed around a first idler pulley 242 and a second idler pulley 244 between the first section 246A and the second section 246B. The second tensile member 246 can be an elongated member having a first segment 252, a second segment 254, and a third segment 256. The first segment 252 can extend between the wheel member 231 and the first idler pulley 242, the second segment 254 can extend between the first idler pulley 242 and the second idler pulley 244, and the third segment 256 can extend between the second idler pulley 244 and the anchor 247. In the low force orientation shown in FIG. 9A (e.g., the anchor 247 can be coupled to the movable bracket 121 using the second fastener 249), a length of the first segment 252 and a length of the third segment 256 can stay constant (e.g., lengths of the first segment 252 and the third segment 256 cannot change as the movable bracket 121 translates relative to the support column 111).

On the other hand, In the low force orientation, a length of the second segment 254 can increase or decrease as the movable bracket 121 translates relative to the support column 111 along the range of travel 205. For example, if the movable bracket 121 moves towards the first section 201 by the first distance 250, a distance between the first idler pulley 242 and the second idler pulley 244 can increase by the first distance 250, therefore, the length of the second segment 254 can increase by the same amount (e.g., increase by the first distance 250). Similarly, the length of the second segment 254 can decrease as the movable bracket 121 moves towards the second section 202. The reduction in the length of the second segment 254 can be equivalent to the amount of travel of the movable bracket 121 towards the second section 202.

The movable bracket 121 can be configured to urge the wheel assembly 230 to rotate in a clockwise direction as it translates towards the first section 201 of the support column 111. The second tensile member 246 can initially be wrapped around the wheel member 231 proximate the first section 246A when the movable bracket 121 is in the high position (e.g., located proximate the second section 202, as illustrated in FIG. 7). A section of the second tensile member 246 (e.g., a section of the first segment 252 proximate the first section 246A) can unwrap from the wheel member 231 as the wheel assembly 230 rotates in the clockwise direction.

As discussed above, the one or more springs 212 can bias the wheel assembly 230 to rotate in a counterclockwise direction. When the movable bracket 121 translates towards the second section 202 of the support column 111, a slack can occur on the second tensile member 246. As the wheel assembly 230 can rotate in the counterclockwise direction under the influence of the one or more springs 212, a section of the second tensile member 246 (e.g., a section of the first segment 252 proximate the first section 246A) can wrap around the wheel member 231 to take up the slack on the second tensile member 246.

Any increase in the length of the second segment 254 (e.g., an increase equivalent to the first distance 250) as the movable bracket 121 translates towards the first section 201 can be supplied by the first segment 252. Since the movable bracket 121 is operationally coupled to the wheel assembly 230 via the second tensile member 246, the wheel assembly 230 can rotate in a clockwise direction by a first rotation angle 260 when the movable bracket translates by the first distance 250. The first rotation angle 260 can be roughly calculated by dividing the first distance 250 by a wheel radius 236. A section of the second tensile member 246 (e.g., a section equivalent in length to the first distance 250) can unwrap from the wheel member 231 and feed in to the first segment 252 proximate the first section 246A. A slice of the first segment 252 (e.g., a slice equivalent in length to the first distance 250) can shift to the second segment 254 over the first idler pulley 242 to support the increase in the length of the second segment 254.

Returning to FIG. 9B, a section of the first tensile member 240 (e.g., a section proximate the cam member 232) can wrap around the cam member 232 as the wheel assembly 230 rotates in the clockwise direction by the first rotation angle 260. A length of the section of the first tensile member 240 that wraps around the cam member 232 can be roughly calculated by multiplying the first rotation angle 260 with a radius of the cam member 232. It can be appreciated that the radius of the cam member 232 can vary along a periphery of the cam member 232. The varying radius of the cam member 232 can be taken into consideration while calculating the length of the first tensile member 240 that wraps around the cam member 232. The one or more springs 212 can be stretched (e.g., the second spring plate 216 can move towards the wheel assembly 230 by deflecting the second portion 212B of the one or more springs 212) to allow the first tensile member 240 to wrap around the cam member 232. As the movable bracket 121 translates towards the first section 201, the amount of deflection of the one or more springs 212 (e.g., the second deflection 228) can increase. The increase in the deflection of the one or more springs 212 (e.g., the second deflection 228) can be equivalent to the length of the section of the first tensile member 240 that wraps around the cam member 232 as the wheel assembly 230 rotates by the first rotation angle 260.

Typical forces acting in a lift mechanism 100 in a low force orientation are illustrated in FIG. 9A. Typical forces can include a first force 262 (e.g., a force generated by the one or more springs 212), a second force 263, a third force 264, and a fourth force 265. The second force 263, the third force 264, and the fourth force 265 can cooperate to generate a lift force 270A applied to the movable bracket 121 in the low force orientation.

The first force 262 can be supported by the first tensile member 240. The second force 263, the third force 264 and the fourth force 265 can be supported by the first segment 252, the second segment 254 and the third segment 256 of the second tensile member, respectively. Since the first segment 252, the second segment 254 and the third segment 256 can be continuous sections of the second tensile member 246, and the first idler pulley 242 and the second idler pulley 244 can be free to rotate around their respective axes, the second force 263, the third force 264, and the fourth force 265 can be equal in magnitude.

The first force 262 can be applied to the cam member 232 via the first tensile member 240. The first force 262 can be equal to a spring force generated by the one or more springs 212. The spring force (e.g., the first force 262) can be a function of one or more spring parameters and a total deflection of the one or more springs 212. The total deflection of the one or more springs 212 can be a sum of the first deflection 227 (e.g., a deflection of the first portion 212A of the one or more springs 212 coupled to the adjustment assembly 220 via the first spring plate 214) and the second deflection 228 (e.g., a deflection of the second portion 212B of the one or more springs 212 coupled to the cam member 232 via the second spring plate 216 and the first tensile member 240).

The first deflection 227 can define the pre-tension of the one or more springs 212. The adjustment assembly 220 can be configured to set the first deflection 227 as discussed above. The first deflection 227 can stay constant during the translation of the movable bracket 121. As the wheel assembly 230 rotates in a clockwise direction while the movable bracket 121 translates towards the first section 201, the second spring plate 216 can be pulled by the first tensile member 240 as discussed above. The movement of the second spring plate 216 can cause the second deflection 228. The second deflection 228 can increase as the movable bracket 121 translates towards the first section 201, and thus, the first force 262 (e.g., the spring force) can increase.

One or more forces (e.g., the first force 262 and the second force 263) and one or more toques (e.g., a first torque 268 and a second torque 269) acting on the wheel assembly 230 in an equilibrium state are illustrated in FIG. 9B. The first tensile member 240 can be coupled to the cam member 232, and thus, the first tensile member 240 can transmit the first force 262 to the cam member 232 creating the first torque 268. The first torque 268 can apply to the wheel assembly 230 in the counterclockwise direction. In any instant, the first torque 268 can be roughly calculated by multiplying the first force 262 with an instantaneous cam radius 233. The instantaneous cam radius 233 is a radius of the cam member 232 at a contact point between the first tensile member 240 and the cam member 232 at a rotation of the wheel assembly 230 (e.g., at the first rotation angle 260) during the translation of the movable bracket 121. The instantaneous cam radius 233 can vary (e.g., decrease) as a function of the cam rotation (e.g., as the first rotation angle 260 increases) to keep the first torque 268 constant despite a change (e.g., an increase) in the first force 262.

The first torque 268 can be counterbalanced by the second torque 269. The second torque 269 can be created by the second force 263. The second torque 269 can act on the wheel assembly 230 in the clockwise direction. The second torque 269 can be equal to the first torque 268 to maintain the wheel assembly 230 in balance. The second force 263 can be applied to the wheel assembly 230 by the second tensile member 246 coupled to the wheel member 231. The second force 263 can be roughly calculated by dividing the first torque 268 by a wheel radius 236. The wheel radius 236 is a radius of the wheel member 231. In some example configurations, the wheel radius can be constant, in other example configurations it can vary. If the first torque 268 and the wheel radius 236 can be constant, the second force 263 can also be constant.

Returning to FIG. 9A, the second force 263 can be supported by the first segment 252 of the second tensile member 246. The first segment 252 can be coupled to the wheel assembly 230 and the first idler pulley 242. Both the wheel assembly 230 and the first idler pulley 242 can be coupled to the support column 111. Therefore, the second force 263 cannot directly contribute to the lift force 270A acting on the movable bracket 121.

The third force 264 can be supported by the second segment 254 of the second tensile member 246. The second segment 254 can be coupled between the first idler pulley 242 and the second idler pulley 244. The first idler pulley 242 can be coupled to the support column 111 and the second idler pulley 244 can be coupled to the movable bracket 121. Therefore, the third force 264 can act between the support column 111 and the movable bracket 121, and thus, the third force 264 can directly contribute to the lift force 270A acting on the movable bracket 121.

The fourth force 265 can be supported by the third segment 256 of the second tensile member 246. The third segment 256 can be coupled between the second idler pulley 244 and the anchor 247. Both the second idler pulley 244 and the anchor 247 can be coupled to the movable bracket 121 in the low force orientation, as illustrated in FIG. 9A. Therefore, the fourth force 265 can be internal to the movable bracket 121, and thus, the fourth force 265 cannot contribute to the lift force 270A acting on the movable bracket 121 in the low force orientation.

In summary, in the low force orientation of the lift mechanism 100 (e.g., the anchor 247 can be coupled to the movable bracket 121, as illustrated in FIG. 9A), the movable bracket 121 can move a first distance 250 relative to the support column 111 causing a length of the second tensile member 246 increase (e.g., a length of the second segment 254 can increase). In response, the wheel assembly 230 can rotate a first rotation angle 260 to release (e.g., unwrap from the wheel member 231) a section of the second tensile member 246 equivalent in length to the first distance 250, and the first portion 212A of the one or more springs 212 can deflect by a second deflection 228 to allow the first tensile member 240 wrap around the cam member 232. An increasing spring force (e.g., a first force 262 due to the second deflection 228) can act on the cam member 232. A second force 263 can act on the wheel member 231 to keep the wheel assembly 230 in balance. The second force 263 can be calculated from the torque balance of the wheel assembly 230 as discussed above. The second force 263 can be constant despite the increased first force 262 due to varying instantaneous cam radius 233 as discussed above. A lift force 270A can be equivalent to the second force 263 in the low force orientation as discussed above. The lift force 270A can act on the movable bracket 121 to counter a combined weight of the movable bracket 121 and other components coupled to the movable bracket 121.

FIGS. 10A-10B are schematic views of the lift mechanism 100 of FIG. 7 according to an example configuration of the current disclosure. The movable bracket 121 is shown in a low position in FIG. 10A. The movable bracket 121 can translate a first distance 250 from a high position (e.g., proximate the second section 202) towards a low position (e.g., proximate the first section 201).

The lift mechanism 100 is shown in the high force orientation in FIG. 10A. In the high force orientation, the anchor 247 can be coupled to the support column 111 using the first fastener 248. The anchor 247 can stay stationary (e.g., cannot move relative to the support column 111) as the movable bracket 121 translates relative to the support column 111. The first tensile member 240 and the second tensile member 246 can be routed similarly as discussed above in relation to the low force orientation (shown in FIG. 9A).

The length of the second tensile member 246 can change as the movable bracket 121 translates relative to the support column by a first distance 250. The first idler pulley 242 and the wheel assembly 230 can be coupled to the support column 111, therefore, the length of the first segment 252 of the second tensile member 246 cannot change as the movable bracket 121 translates relative to the support column 111. The second idler pulley 244 can be coupled to the movable bracket 121, therefore, a length of the second segment 254 of the second tensile member 246 can change as the movable bracket translates relative to the support column (e.g., the length of the second segment 254 can increase as a distance between the first idler pulley 242 and the second idler pulley 244 can increase as the movable bracket move towards the first section 201). The increase in the length of the second segment 254 can be equal to the amount of translation (e.g., the first distance 250) of the movable bracket 121. Since the anchor 247 can be coupled to the support column in the high force orientation, a length of the third segment 256 of the second tensile member 246 can also change as the movable bracket 121 translates relative to the support column 111. The length of the third segment 256 can increase as a distance between the second idler pulley 244 and the anchor 247 can increase as the movable bracket 121 moves towards the first section 201. The increase in the length of the third segment 256 can be equal to the amount of translation (e.g., first distance 250) of the movable bracket 121.

In the high force orientation (shown in FIG. 10A), total increase in the length of the second tensile member 246 can be equal to two times the first distance 250 (e.g., sum of increases in the lengths of the second segment 254 and the third segment 256, each equal to the first distance 250). A slice of the second segment 254 (e.g., a slice with a length equivalent to the first distance 250) can be shifted to the third segment 256 over the second idler pulley 244 to support the increase in the length of the third segment 256, and a slice of the first segment 252 (e.g., a slice with a length equivalent to two times the first distance 250) can be shifted to the second segment 254 over the first idler pulley 242 to support the increases in the lengths of the second segment 254 and the third segment 256.

The increase in the length of the second tensile member 246 (e.g., two times the first distance 250) can be equivalent to a length of a section of the second tensile member 246 released (e.g., unwrapped) from the wheel member 231 as the wheel assembly 230 rotates in clockwise direction. In the high force orientation (shown in FIG. 10A), the wheel assembly 230 can rotate a second rotation angle 261 (shown in FIG. 10B) to release the length of the second tensile member 246 equivalent to two times the first distance 250. The second rotation angle 261 can be roughly calculated by dividing two times the first distance 250 by the wheel radius 236. The second rotation angle 261 can be larger than the first rotation angle 260 (e.g., two times as large as the first rotation angle 260).

The one or more springs 212 can be operationally coupled to the cam member 232 via the second spring plate 216 and the first tensile member 240. In the high force orientation (illustrated in FIGS. 10A-10B), the second portion 212B of the one or more springs 212 can deflect by a third deflection 229 to allow the first tensile member 240 to wrap around the cam member 232 as the wheel assembly 230 rotates by the second rotation angle 261. The third deflection 229 can be larger than the second deflection 228. The one or more springs 212 can provide a first force 262 applied to the cam member 232 via the first tensile member 240. The first force 262 can increase as the third deflection 229 increases.

Typical forces acting in a lift mechanism 100 in a high force orientation are illustrated in FIG. 10A. Typical forces include a first force 262 (e.g., a force generated by the one or more springs 212, as discussed above), a second force 263, a third force 264, and a fourth force 265. The second force 263, the third force 264, and the fourth force 265 can cooperate to generate a lift force 270B applied to the movable bracket 121 in the high force orientation.

The second force 263 can be roughly calculated based on the torque balance on the wheel assembly 230. The second force 263 can be constant despite an increase in the first force 262 due to variation in the instantaneous cam radius 233 as a function of the second rotation angle 261. The third force 264 and the fourth force 265 can be equal to the second force 263 as discussed in previous sections.

Returning to FIG. 10A, the second force 263 can be supported by the first segment 252 of the second tensile member 246. The first segment 252 can be coupled between the wheel member 231 and the first idler pulley 242. Both the wheel member 231 and the first idler pulley 242 can be coupled to the support column 111; therefore, the second force 263 cannot contribute to a lift force 270B acting on the movable bracket 121.

The third force 264 can be supported by the second segment 254 of the second tensile member 246. The second segment 254 can be coupled between the first idler pulley 242 and the second idler pulley 244 where the first idler pulley 242 can be coupled to the support column 111 and the second idler pulley 244 can be coupled to the movable bracket 121. Therefore, the third force 264 can act between the support column 111 and the movable bracket 121, and thus, the third force 264 can contribute to the lift force 270B acting on the movable bracket 121 in the high force orientation.

The fourth force 265 can be supported by the third segment 256 of the second tensile member 246. The third segment 256 can be coupled between the second idler pulley 244 and the anchor 247. The anchor 247 can be coupled to the support column 111; therefore, the fourth force 265 can act between the support column 111 and the movable bracket 121, and thus, the fourth force 265 can contribute to the lift force 270B acting on the movable bracket 121 in the high force orientation.

In summary, in the high force orientation of the lift mechanism 100 (e.g., the anchor 247 can be coupled to the support column 111, as illustrated in FIG. 10A), the movable bracket 121 can move a first distance 250 relative to the support column 111 causing a length of the second tensile member 246 increase (e.g., a length of the second segment 254 and a length of the third segment 256 can increase, each increase can be equivalent to the first distance 250). In response, the wheel assembly 230 can rotate a second rotation angle 261 to release (e.g., unwrap from the wheel member 231) a length of the second tensile member 246 equivalent to two times the first distance 250, and the second portion 212B of the one or more springs 212 can deflect a third deflection 229 to allow the first tensile member 240 wrap around the cam member 232. An increasing spring force (e.g., a first force 262) can act on the cam member 232, and a second force 263 can act on the wheel member 231 to keep the wheel assembly 230 in balance. The second force 263 can be calculated from the torque balance of the wheel assembly 230 as discussed in previous sections. The second force 263 can be constant despite an increase in the first force 262 due to varying cam radius. A lift force 270B can be equivalent to two times the second force 263. The lift force 270B in the high force orientation (shown in FIG. 10A) can be larger (e.g., twice as large) than the lift force 270A in the low force orientation (shown in FIG. 9A). The lift force 270B can counter a combined weight of the movable bracket 121 and other components coupled to the movable bracket 121 in a high force orientation.

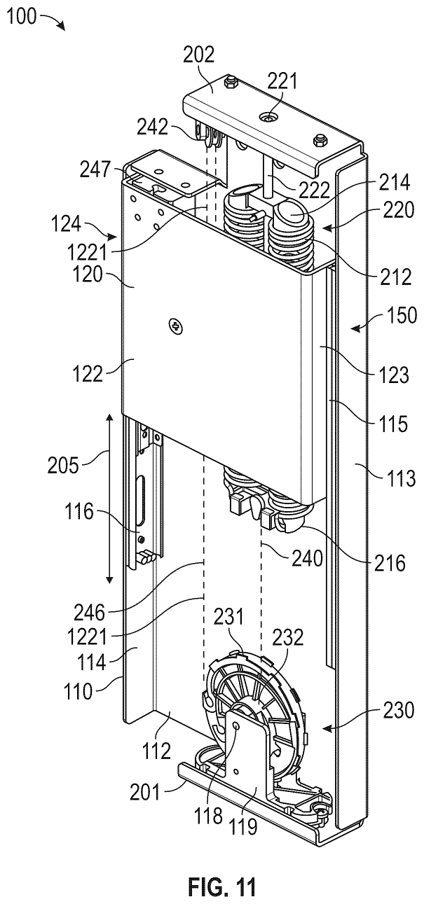

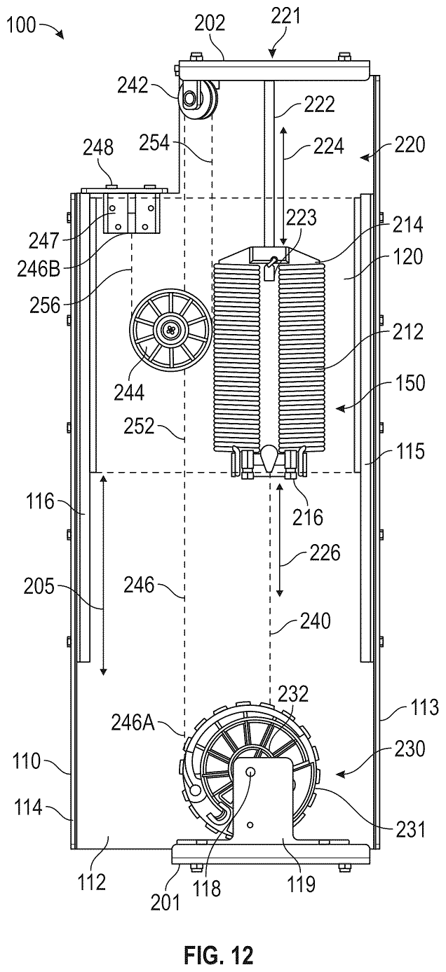

FIG. 11 is a perspective view of the lift mechanism 100 according to an example configuration of the current disclosure. The lift mechanism 100 can include a fixed portion 110 and a movable portion 120. The movable portion 120 can be slidingly engaged with the fixed portion 110. FIGS. 12-15 are front views of the lift mechanism of FIG. 11. In FIGS. 12-15, the movable portion 120 is rendered transparent for clarity.

The fixed portion 110 can be elongated between a first section 201 and a second section 202. The fixed portion 110 can also include a fixed portion first wall 112, a fixed portion second wall 113, and a fixed portion third wall 114. The fixed portion 110 can be made from any engineering material including, but not limited to, sheet metal, die cast, molded plastic, or the like. The first section 201, the second section 202, the fixed portion second wall 113, and the fixed portion third wall 114 can extend from the fixed portion first wall 112 in a transverse direction. A section 1121 of the fixed portion 110 opposite the fixed portion first wall 112 can be open to accept the movable portion 120. In some example configurations, the fixed portion 110 can be coupled to a structure (e.g., a wall, a pole, a wheeled base, a desk clamp, or the like).

The movable portion 120 can be formed in a U-shape having a movable portion first wall 122, a movable portion second wall 123, and a movable portion third wall 124. The movable portion 120 can be made from any engineering material including, but not limited to, sheet metal, die cast, molded plastic, or the like. The movable portion second wall 123 and the movable portion third wall 124 can extend from the movable portion first wall 122 in a transverse direction. A section 1221 of the movable portion 120 opposite the movable portion first wall 122 can be open to accept one or more of the internal components (e.g., one or more springs 212) of the lift mechanism 100. The movable portion first wall 122 can be coupled to a component 130 (e.g., a platform 30 of FIG. 2, a work surface 33 of FIG. 3, an interactive display 41 of FIG. 4, or the like).

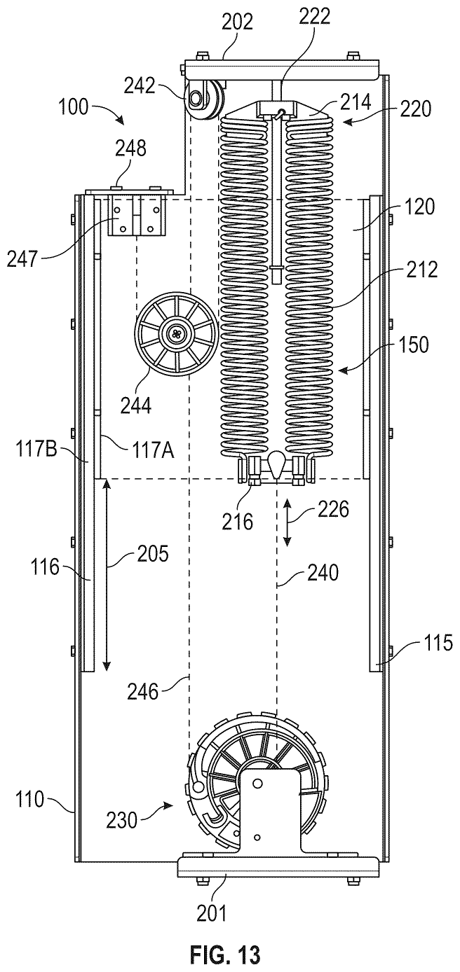

The movable portion second wall 123 can be located across the fixed portion second wall 113, and the movable portion third wall 124 can be located across the fixed portion third wall 114. The movable portion first wall 122 can be located across and away from the fixed portion first wall 112. A first slider 115 can be located between the movable portion second wall 123 and the fixed portion second wall 113, and a second slider 116 can be located between the movable portion third wall 124 and the fixed portion third wall 114. The first slider 115 and the second slider 116 each can have an inner race 117A and an outer race 117B (shown in FIG. 13). The movable portion 120 can be coupled to the inner race 117A of the first slider 115 and the second slider 116, and the fixed portion 110 can be coupled to the outer race 117B of the first slider 115 and second slider 116. The first slider 115 and the second slider 116 can be configured to guide the movable portion 120 as it translates relative to the fixed portion 110 through a range of travel 205.

The lift mechanism can also include a counterbalance mechanism 150. The counterbalance mechanism 150 can be located inside the fixed portion 110 and the movable portion 120 (e.g., located between the fixed portion first wall 112 and the movable portion first wall 122). In some example configurations, the counterbalance mechanism 150 can include an adjustment assembly 220, one or more springs 212 and a wheel assembly 230. The counterbalance mechanism 150 can be operationally coupled between the fixed portion 110 and the movable portion 120. The counterbalance mechanism 150 can be configured to generate a lift force to counter at least a portion of the combined weight of the movable portion 120 and the component 130 coupled to the movable portion 120.

The wheel assembly 230 can be rotatably coupled to the fixed portion 110 proximate the first section 201. In some example configurations, a holding block 119 can be coupled to the fixed portion 110 proximate the first section 201 and the wheel assembly 230 can be rotatably coupled to the holding block 119.

In some example configurations, the wheel assembly can include a wheel member 231 and a cam member 232. The cam member 232 can be fixedly attached to the wheel member 231. In some example configurations, the cam member 232 and the wheel member 231 can be a single component in which the cam member 232 can be formed in the wheel member 231. In general, the wheel member 231 can have a constant outside radius, and the cam member 232 can have a varying outside radius. The wheel member 231 and the cam member 232 can be concentric, and they can rotate around a wheel axle 118 in unison.

The one or more springs 212 can be coupled to a first spring plate 214 on a first portion 212A and coupled to a second spring plate 216 on the second portion 212B. The first spring plate 214 can be coupled to the adjustment assembly 220 proximate the second section 202. The second spring plate 216 can be coupled to the wheel assembly 230 via a first tensile member 240 (e.g., a line, cord, string, rope, chain, ribbon, belt, or the like). The first tensile member 240 can be made of an engineering material including, but not limited to, natural fibers, metal, polymer, single-strand, or the like. The one or more springs 212 can bias the wheel assembly 230 to rotate in a counterclockwise direction.

The counterbalance mechanism 150 can also include a second tensile member 246 (e.g., a line, cord, string, rope, chain, ribbon, belt, or the like) having a first section 246A and a second section 246B (shown in FIG. 12). The first section 246A can be coupled to the wheel assembly 230 and the second section 246B can be coupled to an anchor 247. In some example configurations, the second tensile member 246 can be routed around a first idler pulley 242 and a second idler pulley 244 between the first section 246A and the second section 246B. The first idler pulley 242 can be rotatably coupled to the fixed portion 110 proximate the second section 202 and the second idler pulley 244 can be rotatably coupled to the movable portion 120. The second tensile member 246 can be made of an engineering material including, but not limited to, natural fibers, metal, polymer, single-strand, or the like.

The second tensile member 246 can have a first segment 252, a second segment 254, and a third segment 256. The first segment 252 can extend between the wheel assembly 230 and the first idler pulley 242, the second segment 254 can extend between the first idler pulley 242 and the second idler pulley 244, and the third segment 256 can extend between the second idler pulley 244 and the anchor 247. In some example configurations, a length of the second tensile member 246 (e.g., a length of the second segment 254 or a length of the third segment 256) can increase as the movable portion 120 translates relative to the fixed portion 110 towards the first section 201 as discussed in the previous sections. A slice of the first segment 252 can shift to the second segment 254 over the first idler pulley 242, a slice of the second segment 254 can shift to the third segment 256 over the second idler pulley 244, and additional sections can be added to the first segment 252 proximate the first section 246A to allow for the increase in the length of the second tensile member 246.

The adjustment assembly 220 can include an adjustment screw 222 having a screw head 221 and a screw tip 223. The adjustment screw 222 can be coupled to the fixed portion 110 (e.g., the screw head 221 can be coupled to the second section 202) and threadedly engaged with the first spring plate 214. The first spring plate 214 can be configured to translate along an axial direction of the adjustment screw 222 through a range of adjustment 224 (e.g., including a low adjustment and a high adjustment) as the adjustment screw 222 is rotated (e.g., the first spring plate 214 can be proximate the screw tip 223 at the low adjustment and proximate the screw head 221 at the high adjustment).

The adjustment assembly 220 can be configured to adjust a tension (e.g., pre-tension) of the one or more springs 212. The one or more springs can have a lower pre-tension at the low adjustment (e.g., when the first spring plate 214 is proximate the screw tip 223, as illustrated in FIG. 12) compared to the pre-tension at the high adjustment (e.g., when the first spring plate 214 is proximate the screw head 221, as illustrated in FIG. 13). The one or more springs 212 can be configured to generate a low spring force when the pre-tension is low, and the one or more springs 212 can be configured to generate a high spring force when the pre-tension is high. Similarly, the lift mechanism 100 can be configured to generate a low lift force when the pre-tension is low, and the lift mechanism 100 can be configured to generate a high lift force when the pre-tension is high.

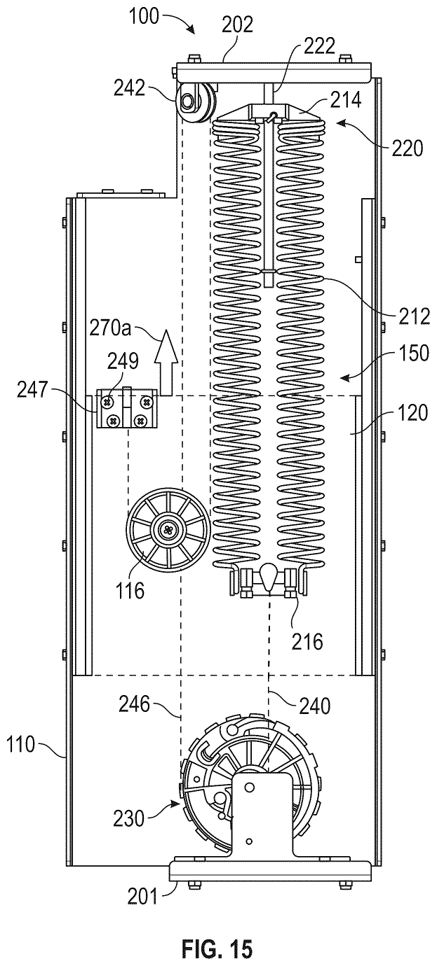

The anchor 247 can be selectively coupled to either one of the fixed portion 110 or the movable portion 120. In some example configurations, the anchor 247 can be coupled to the fixed portion 110 using one or more of the first fasteners 248, as illustrated in FIGS. 12-14, in other example configurations, the anchor 247 can be coupled to the movable portion 120 using one or more of the second fasteners 249, as illustrated in FIG. 15. The anchor 247 can be selectively coupled to the fixed portion 110 or the movable portion 120 to put the lift mechanism 100 in a high force orientation, as illustrated in FIGS. 12-14, or in a low force orientation, as illustrated in FIG. 15, respectively.

The anchor 247 can take many different shapes and forms including, but not limited to, a block, a screw, a hook, a pin, or the like. There can be many different methods and mechanisms to selectively couple the anchor 247 to the fixed portion 110 or movable portion 120 including, but not limited to, a slider, a rotator, or the like. Some of these mechanisms and methods will be discussed in the later sections of this disclosure. These methods and mechanisms can be operated by the user of the lift mechanism 100 to selectively couple the anchor 247 to the fixed portion 110 or to the movable portion 120.

The second tensile member 246 can be operationally coupled to the movable portion 120 and the wheel assembly 230. As the movable portion 120 translates relative to the fixed portion 110, the movable portion 120 can urge the wheel assembly 230 to rotate in a clockwise direction. The wheel assembly 230 can be configured to rotate more when the anchor 247 is coupled to the fixed portion 110 (e.g., the second rotation angle 261 in the high force orientation, as illustrated in FIGS. 10-14) compared to a rotation angle when the anchor 247 is coupled to the movable portion 120 (e.g., the first rotation angle 260 in the low force orientation, as illustrated in FIGS. 9 and 15). For example, the second rotation angle 261 can be twice as high as the first rotation angle 260. The second portion 212B of the one or more springs 212 can be adapted to deflect through a range of deflection 226 as the wheel assembly 230 rotates in the clockwise direction relative to the fixed portion 110.

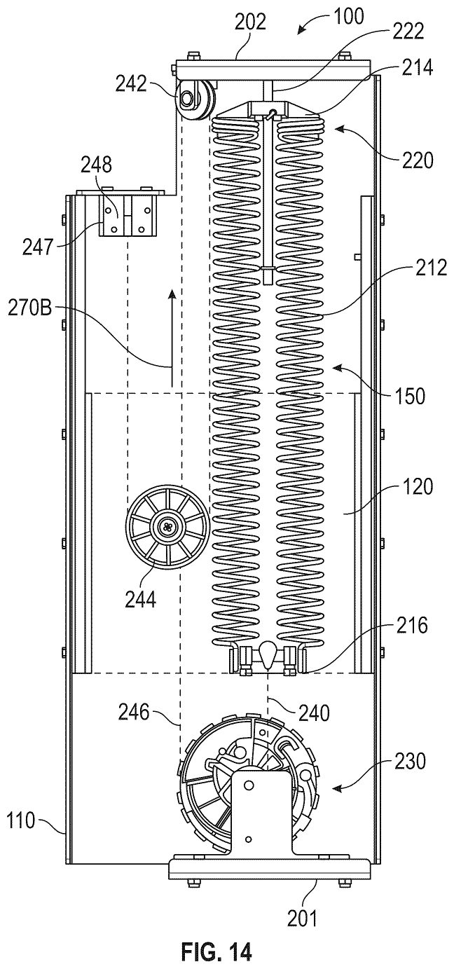

The first portion 212A of the one or more springs 212 can be displaced by a first deflection 227 (shown in FIGS. 9A and 10A) within the range of adjustment 224 (e.g., a deflection caused by rotating the adjustment screw 222), and the second portion 212B of the one or more springs 212 can be displaced by a second deflection 228 (e.g., shown in FIG. 9A in the low force orientation) or by a third deflection 229 (e.g., shown in FIG. 10A in the high force orientation) within the range of deflection 226 (e.g., a deflection caused by a translation of the movable portion 120). A total deflection of the one or more springs 212 can be equal to a sum of the first deflection 227 and the second deflection 228 in the low force orientation, or equal to a sum of the first deflection 227 and the third deflection 229 in the high force orientation. A spring force generated by the one or more springs (e.g., equivalent to the first force 262, as discussed in previous sections in relation to FIGS. 9-10) can apply on the wheel assembly 230 via the first tensile member 240. The magnitude of the first force 262 can depend on the total deflection of the one or more springs 212 and one or more spring parameters. The first force 262 can be converted to a lift force 270 (e.g., the lift force 270A in the low force orientation, as illustrated in FIG. 15, or a lift force 270B in the high force orientation, as illustrated in FIG. 14) by a torque balance over the wheel assembly 230 as discussed in the previous sections.

The counterbalance mechanism 150 can apply a lift force 270 (e.g., lift force 270A of FIG. 15, or lift force 270B of FIG. 14) to the movable portion 120. The lift force 270 applied to the movable portion 120 can help reduce an amount of force required to translate the movable portion 120 relative to the fixed portion 110. The lift mechanism 100 can be balanced when the lift force 270 is equivalent to the combined weight of the movable portion 120 and the weight of the other components coupled to the movable portion 120. When the lift mechanism 100 is balanced, the amount of user applied force necessary to translate the movable portion 120 can remain substantially constant despite increasing force (e.g., the first force 262) created by the one or more springs 212, and an operator of the lift mechanism 100 can position a component coupled to the movable portion 120 at any desired height along the range of travel 205, having only to overcome a friction between the sliding portions (e.g., overcome a friction inherent in the first slider 115 and the second slider 116) of the lift mechanism 100. Additionally, the counterbalance mechanism 150 can help maintain a position of the movable portion 120 with respect to the fixed portion 110 without requiring an operator to engage an optional position stop mechanism if present.

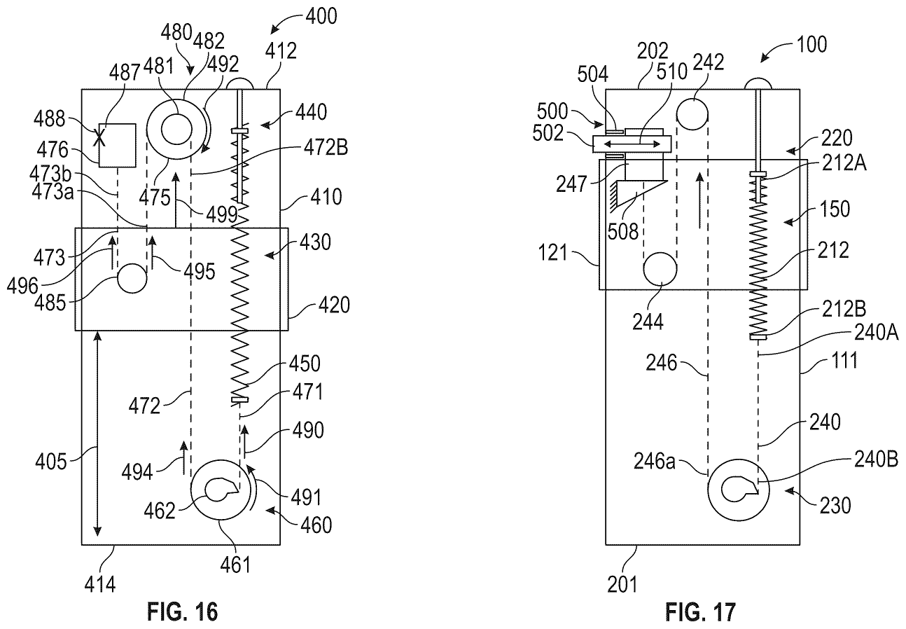

FIG. 16 is a schematic view of a lift mechanism 400 according to an example configuration of the current disclosure. The lift mechanism 400 can include a support column 410, a movable bracket 420, and a counterbalance mechanism 430. The movable bracket 420 is rendered transparent for clarity in FIG. 16. The support column 410 can be elongated between a first section 412 and a second section 414. The movable bracket 420 is shown in a high position (e.g., the movable bracket 420 is proximate the second section 414) in FIG. 16. The movable bracket 420 can be configured to translate in a range of travel 405 relative to the support column 410 between the second section 414 and the first section 412.

The counterbalance mechanism 430 can be operationally coupled between the movable bracket 420 and the support column 410. The counterbalance mechanism 430 can include an adjustment assembly 440, one or more springs 450 (e.g., extension springs, compression springs, leaf springs, or the like), and a wheel assembly 460. The adjustment assembly 440 can be coupled between the support column 410 proximate the second section 414 and the one or more springs 450. The adjustment assembly 440 can be configured to adjust a pre-tension of the one or more springs 450 as discuss in previous sections.

The wheel assembly 460 can be rotatably coupled to the support column 410 proximate the first section 412. The wheel assembly 460 can include a wheel member 461 and a cam member 462 coupled to the wheel member 461. In some example configurations, the cam member 462 and the wheel member 461 can be a single component in which the cam member 462 can be formed in the wheel member 461. The wheel member 461 and the cam member 462 can rotate in unison around an axle located at the center of the wheel member 461.

The one or more springs 450 can be operationally coupled to the wheel assembly 460 (e.g., coupled to the cam member 462) via a first tensile member 471. The first tensile member 471 can be an elongated member (e.g., a line, cord, string, rope, chain, ribbon, belt, or the like). The one or more springs 450 can bias the wheel assembly 460 to rotate in a counterclockwise direction.

In some example configurations, the lift mechanism 400 can also include a transition pulley assembly 480 and an idler pulley 485. The transition pulley assembly 480 can be rotatably coupled to the support column 410 proximate the second section 414, and the idler pulley 485 can be rotatably coupled to the movable bracket 420. The transition pulley assembly 480 can include a first transition pulley 481 and a second transition pulley 482 coupled to the first transition pulley 481. In general, the first transition pulley 481 can have a smaller radius compared to a radius of the second transition pulley 482. In some example configurations, the first transition pulley 481 can be formed as an integral part of the second transition pulley 482.

The lift mechanism can also include a second tensile member 472 and a third tensile member 473. The wheel assembly 460 can be coupled to the transition pulley assembly 480 via the second tensile member 472. For example, a first portion 472A of the second tensile member 472 can be coupled to the wheel member 461 and a second portion 472B of the second tensile member 472 can be coupled to the first transition pulley 481, as illustrated in FIG. 16.

The third tensile member 473 can have a first section 475 and a second section 476. The first section 475 can be coupled to the second transition pulley 482 and the second section 476 can be coupled to an anchor 487. The third tensile member 473 can be routed around the idler pulley 485 between the first section 475 and the second section 476, as illustrated in FIG. 16. The third tensile member 473 can cooperate with the idler pulley 485 to operationally couple the counterbalance mechanism 430 to the movable bracket 420.

The anchor 487 can be selectively coupled to either the support column 410 or the movable bracket 420 to put the lift mechanism 400 in a high force orientation or a low force orientation, respectively, as discussed in the previous sections. The anchor 487 is represented as coupled to the support column 410 using a mechanical fastener 488 in FIG. 16.

The third tensile member 473 can have a first segment 473A, and a second segment 473B. The first segment 473A can extend between the second transition pulley 482 and the idler pulley 485, and the second segment 473B can extend between the idler pulley 485 and the anchor 487. An explanation of forces within the lift mechanism 400 in an equilibrium state will now be provided according to some embodiments.

When the illustrated embodiment of the lift mechanism 400 of FIG. 16 is in an equilibrium state, the one or more springs 450 can deflect and create a spring force 490 (e.g., as explained in relation to FIGS. 9-10 in previous sections). The spring force 490 can be transmitted to the cam member 462 via the first tensile member 471. The spring force 490 can apply a first torque 491 on the wheel assembly 460. The first torque 491 can urge the wheel assembly 460 to rotate in a counterclockwise direction and create a first force 494 on the second tensile member 472. A magnitude of the second force 495 can be calculated from the torque balance over the wheel assembly 460 as discussed in previous sections.

The first force 494 supported by the second tensile member 472 can apply to the first transition pulley 481 and create a second torque 492 on the transition pulley assembly 480. The second torque 492 can urge the transition pulley assembly 480 to rotate in clockwise direction and create a second force 495 on the first segment 473A of the third tensile member 473. A magnitude of the second force 495 can be calculated by multiplying the magnitude of the first force 494 by the ratio of a radius of the first transition pulley 481 to a radius of the second transition pulley 482. In other words, the transition pulley assembly can scale the first force 494 by a scale factor (e.g., the ratio of the first radius to the second radius) to create the second force 495.

Since the third tensile member 473 can be a continuously elongated member formed by the first segment 473A and the second segment 473B, the second force 495 carried by the first segment 473A can be also carried by the second segment 473B. Therefore, a third force 496 can be created on the second segment 473B. A magnitude of the third force 496 can be equal to a magnitude of the second force 495. Both the second force 495 and the third force 496 can act on the idler pulley 485 in a direction towards the second section 414 of the support column 410, as illustrated in FIG. 16.

In the high force orientation (e.g., the anchor 487 can be coupled to the support column 410, as illustrated in FIG. 16), the second force 495 and the third force 496 can be added to create a lift force 499. In the low force orientation (e.g., the anchor 487 can be coupled to the movable bracket 420, as illustrated in FIG. 9A), only the second force 495 can contribute to the lift force 499. Therefore, the lift force 499 can be twice as high in the high force orientation compared to the lift force 499 in the low force orientation.

FIGS. 17-19 are schematic views of the lift mechanism 100 of FIG. 7 according to some example configurations of the current disclosure.

The lift mechanism 100 can include a support column 111 and a movable bracket 121. The movable bracket 121 is rendered transparent in FIGS. 17-19 for clarity.

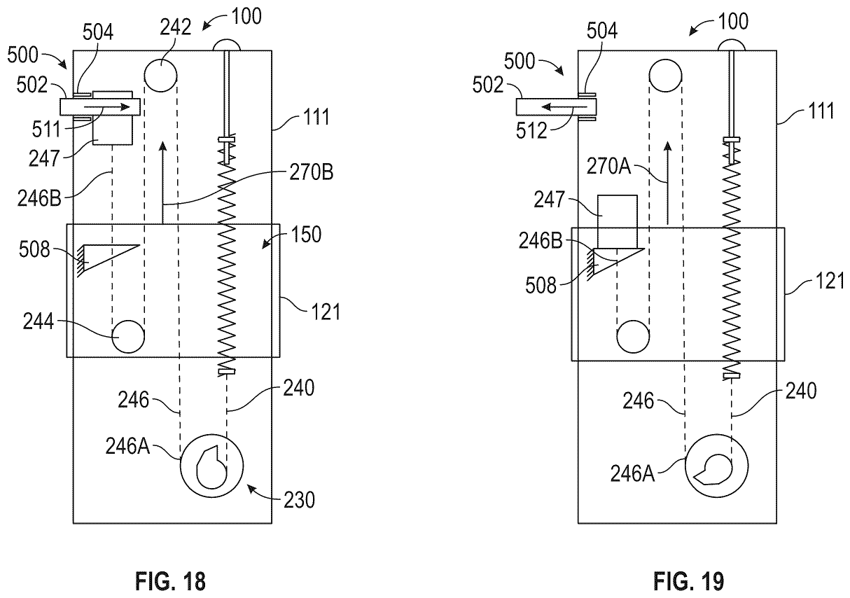

The lift mechanism 100 can also include a coupler mechanism 500. The coupler mechanism 500 can be configured to couple the anchor 247 to the support column 111 (as illustrated in FIG. 18) to put the lift mechanism 100 in the high force orientation. Alternatively, the coupler mechanism 500 can decouple the anchor 247 from the support column 111 (e.g., as a result the anchor 247 can be coupled to the movable bracket 121, as illustrated in FIG. 19) to put the lift mechanism 100 in the low force orientation. Using the coupler mechanism 500, a user of the lift mechanism 100 can selectively couple or decouple the anchor 247 from the support column 111 for changing the orientation of the lift mechanism 100 between the high force orientation and the low force orientation, respectively.

In some example configurations, the coupler mechanism 500 can include a glider 502 and a glider support 504. The glider support 504 can be coupled to the support column 111. The glider 502 can be movably (e.g., slidably, rotatably, or the like) engaged with the glider support 504. The glider 502 can be configured to translate relative to the support column 111 within a range of motion 510 (shown in FIG. 17). The glider support 504 can guide the glider 502 during its translation relative to the support column 111 within the range of motion 510.

The glider 502 can translate in a first direction 511 (shown in FIG. 18) or in a second direction 512 (shown in FIG. 19) to engage or disengage with the anchor 247, respectively. In some example configurations, the glider 502 can only engage with the anchor 247 when the movable bracket 121 is in the high position (e.g., proximate the second section 202).

In some example configurations, the lift mechanism 100 can also include a shelf 508. The shelf 508 can be fixedly attached to the movable bracket 121. In the low force orientation of the lift mechanism 100, the anchor 247 can be seated on the shelf 508. The shelf 508 can be configured to carry the anchor 247 and support the third force 496 acting on the anchor 247 via the third tensile member 473. The shelf 508 can be made from any engineering material including, but not limited to, sheet metal, die cast aluminum, molded plastic, or the like. In some example configurations, the shelf 508 and the movable bracket 121 can be formed in a single component in which the shelf 508 can be formed in the movable bracket 121. For example, the shelf 508 can be a tab bent out of the movable bracket 121 (e.g., bent out of the movable portion first wall 122 of FIG. 11).

The glider 502 can have a coupled configuration and a decoupled configuration. The glider 502 can translate in the first direction 511 relative to the support column 111 to the coupled configuration, as illustrated in FIG. 18. In the coupled configuration, the glider 502 can engage with the anchor 247 to couple the anchor 247 to the support column 111. In the coupled configuration, the anchor 247 can stay stationary as the movable bracket 121 translates relative to the support column 111 from the high position towards the low position to put the lift mechanism in the high force orientation. In the high force orientation, the lift force 270B can be equal to twice as much as the force supported by the second tensile member 246 (e.g., twice as much as the second force 263, shown in FIG. 10A).

In the decoupled configuration, the glider 502 can move in the second direction 512 relative to the support column 111, as illustrated in FIG. 19. In the decoupled configuration, the glider 502 can disengage from the anchor 247. The anchor 247 can be seated on the shelf 508. The shelf 508 and the anchor 247 can translate together with the movable bracket 121 to put the lift mechanism 100 in the low force orientation. In the low force orientation (e.g., the glider 502 can be disengaged from the anchor 247 and the anchor 247 can be coupled to the movable bracket 121, as illustrated in FIG. 19). The lift force 270A can be equal to the force supported by the second tensile member 246 (e.g., the lift force 270A can be equal to the third force 264 supported by the second segment 254, as illustrated in FIG. 9A).

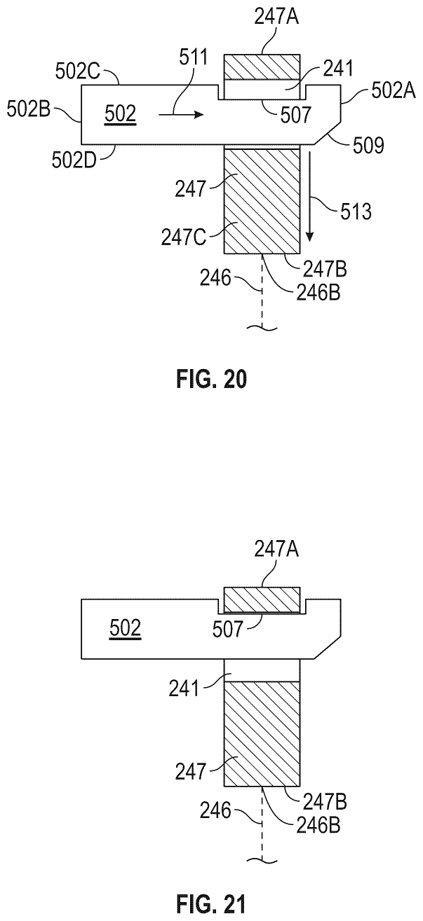

FIGS. 20-21 are schematic views of the glider 502 and the anchor 247 of FIGS. 17-19 according to some example configurations of the current disclosure. The glider 502 can cooperate with the anchor 247 to put the lift mechanism 100 in a high force orientation or a low force orientation. The glider 502 can be an elongated member between a first side 502A and a second side 502B opposite the first side 502A. The glider 502 can also have a third side 502C and a fourth side 502D extending between the first side 502A and the second side 502B. A recess 507 can be formed on the third side 502C proximate the first side 502A. In some example configurations, a notch 509 can be formed at the intersection of the first side 502A and the fourth side 502D. The glider 502 can be formed from any engineering material including, but not limited to, sheet metal, tube, rod, die cast aluminum, molded plastic, or the like.

In some example configurations, the anchor 247 can be an elongated member between a first section 247A and a second section 247B. The second section 246B of the second tensile member 246 (shown in FIG. 7) can be coupled to the second section 247B. The anchor 247 can have an anchor body 247C. The anchor 247 can be made from any engineering material including, but not limited to, sheet metal, steel tube, rod, die cast aluminum, molded plastic, or the like. An aperture 241 can be formed on the anchor body 247C proximate the first section 247A.

The glider 502 can be operatively coupled to the anchor 247. When the movable bracket 121 is in the high position, the glider 502 can translate in a first direction 511 to place the lift mechanism 100 in the coupled configuration, as illustrated in FIG. 18. In the coupled configuration, the glider 502 can be inserted into the aperture 241 such that the glider 502 at least partially located inside the aperture 241. The notch 509 can facilitate the glider 502 entering the aperture 241. In the coupled configuration, at least a portion of the recess 507 can overlap with the anchor 247. The force supported by the second tensile member 246 (e.g., fourth force 265 shown in FIGS. 9A-10) can bias the anchor 247 in a third direction 513, and thus, at least a portion of the anchor 247 can be pulled into the recess 507, as illustrated in FIG. 21, to prevent the glider 502 moving in a second direction 512 opposite the first direction 511 to release the anchor 247 when the movable bracket 121 is away from the high position.

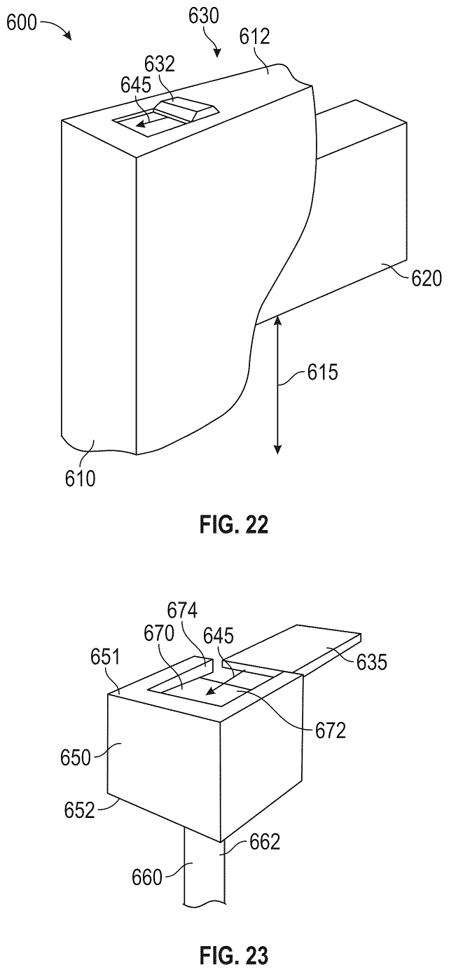

FIG. 22 is partial perspective view of a lift mechanism 600 according to an example configuration of the current disclosure. The lift mechanism 600 can have a fixed portion 610 and movable portion 620. The movable portion 620 can be at least partially located inside the fixed portion 610. The movable portion 620 can be slidingly engaged with the fixed portion 610.

The movable portion 620 can be configured to translate relative to the fixed portion 610 along a range of travel 615. The lift mechanism 600 can provide height adjustment for a component coupled to the movable portion 620. The lift mechanism 600 of FIG. 22 can include one or more embodiments described in previous sections in relation to FIGS. 7-21.

In some example configurations, the lift mechanism 600 can include a coupler mechanism 630 (e.g., similar to the coupler mechanism 500 of FIG. 17). The coupler mechanism can be coupled to the fixed portion 610 proximate a first section 612 (e.g., proximate the second section 202 of the lift mechanism 100 of FIG. 17). The lift mechanism 600 can include a glider tab 632. The glider tab 632 can be fixedly attached to a glider 635 shown in FIG. 23 (e.g., similar to the glider 502 of FIG. 17). The glider tab 632 can be at least partially exposed above the first section 612. The glider tab 632 and the glider 635 can be configured to slide relative to the fixed portion 610 in a first direction 645 or in a second direction opposite the first direction 645. A user of the lift mechanism 600 can manipulate (e.g., move, rotate, push, or the like) the glider tab 632 to selectively put the lift mechanism 600 in a coupled configuration, as illustrated in FIG. 18, or in a decoupled configuration, as illustrated in FIG. 19.

FIG. 23 is a perspective view of an anchor 650 and a glider 635 according to an example configuration of the current disclosure. The glider tab 632 of FIG. 22 can be coupled to the glider 635. The glider 635 can be adapted to translate together with the glider tab 632 in the first direction 645 when the glider tab 632 is manipulated by the user of the lift mechanism 600.

The anchor 650 can have a first section 651 and a second section 652. A section 662 of a second tensile member 660 (e.g., the second section 246B of the second tensile member 246 of FIG. 17) can be coupled to the second section 652 of the anchor 650 and a pocket 670 can be formed on the first section 651 of the anchor 650. The pocket 670 can have an open section 672 and a lip 674 can be formed at least a portion of the periphery of the open section 672. When the glider 635 is translated in the first direction 645, the glider 635 can enter the open section 672 of the pocket 670. The glider 635 can be at least partially located under the lip 674 to couple the anchor 650 with the fixed portion 610 in the coupled configuration. Therefore, the glider 635 can prevent the anchor 650 from translating together with the movable portion 620 in the coupled configuration as discussed in previous sections.

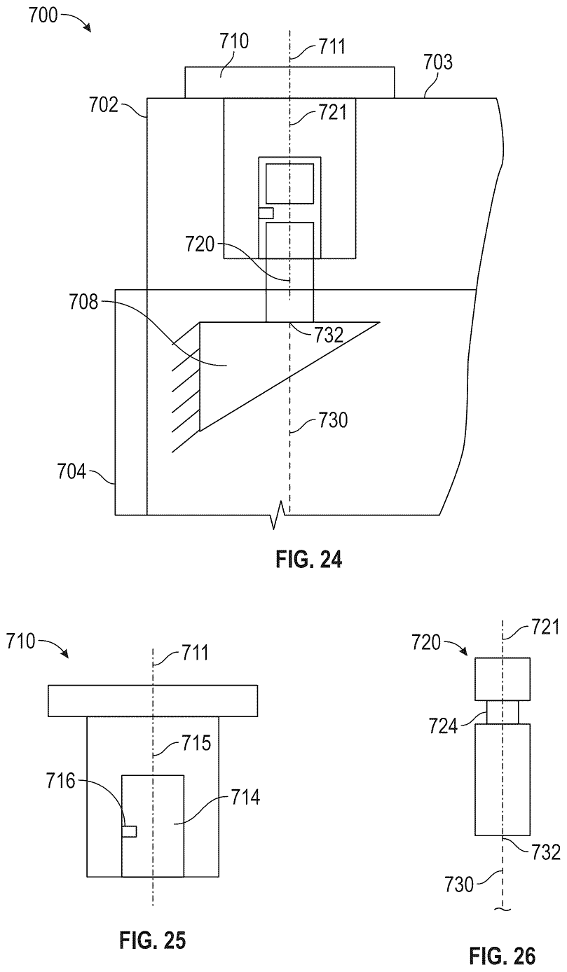

FIG. 24 is a partial schematic view of a lift mechanism 700 according to an example configuration of the current disclosure. The lift mechanism 700 can have a fixed portion 702 and a movable portion 704. Both the fixed portion 702 and the movable portion 704 are rendered transparent for clarity. A block 710 can be coupled to the fixed portion 702 proximate a first section 703 (e.g., proximate the second section 202 of the lift mechanism 100 of FIG. 17). The block 710 can be a round component having a block axis 711.

The block 710 can be rotatably coupled to the fixed portion 702 around the block axis 711. The first section 703 can prevent the block 710 from translating in a direction parallel to the block axis 711.

The lift mechanism 700 can include a pin 720. For example, the pin 720 can be an anchor of any of the embodiments of the lift mechanisms discussed previously (e.g., the anchor of FIG. 10A). The pin 720 can be coupled to a section 732 of a second tensile member 730 (e.g., the second section 246B of the second tensile member 246 of FIG. 17). The pin 720 can be an elongated round component having a pin axis 721. In a decoupled configuration, the pin 720 can rest on a shelf 708 coupled to the movable portion 704, and thus, the pin 720 can be adapted to translate with the movable portion 704.

FIGS. 25-26 are schematic views of the block 710 and the pin 720 of FIG. 24, respectively. The block 710 can define a socket 714. The socket 714 can be a round hole with a hole axis 715. The hole axis 715 can coincide with the block axis 711. The socket 714 can be sized and shaped to receive the pin 720. When the pin 720 is inserted into the socket 714, the pin axis 721 can coincide with the block axis 711. The engagement of the pin 720 with the block 710 can couple the pin 720 to the fixed portion 702 in a coupled configuration.

The block 710 can also include a ridge 716. The ridge 716 can be formed on an inside surface of the socket 714. The ridge 716 can extend from the inside surface of the socket 714 in a radial direction.

The pin 720 can define a groove 724. The groove 724 can be adapted to receive the ridge 716. When the pin 720 is located inside the socket 714, the block 710 can be rotated relative to the fixed portion 702 to insert the ridge 716 into the groove 724 and secure the pin 720 inside the socket 714. The coupling of the pin 720 with the block 710 can inhibit the translation of the pin 720 relative to fixed portion 702 when the movable portion 704 translates relative to the fixed portion 702.

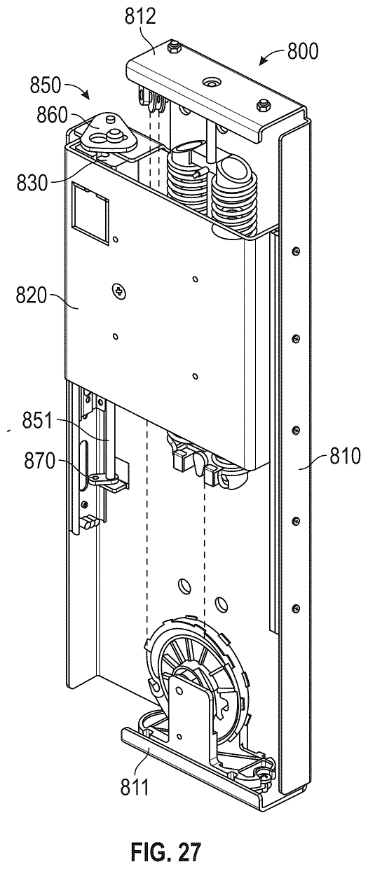

FIG. 27 is a perspective view of a lift mechanism 800 according to an example configuration of the current disclosure. The lift mechanism 800 can include a fixed portion 810 and a movable portion 820 slidably engaged with the fixed portion 810. The fixed portion 810 can extend between a first section 811 and a second section 812. The movable portion 820 can be configured to translate relative to the fixed portion 810 between the first section 811 and the second section 812. The lift mechanism 800 of FIG. 27 can use one or more features of the lift mechanisms described in previous sections (e.g., use one or more features of the lift mechanism 100 of FIG. 11).

The lift mechanism 800 of FIG. 27 can also include an anchor 830 and a coupler mechanism 850. The coupler mechanism 850 can be rotatably coupled with the fixed portion 810. The coupler mechanism 850 can selectively engage with the anchor 830 to couple it to the fixed portion 810.

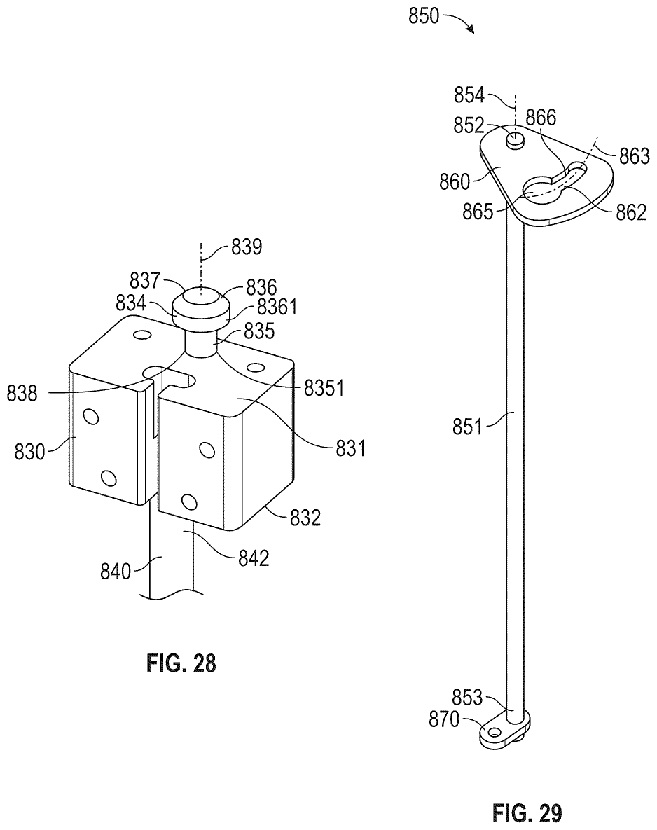

FIG. 28 is a perspective view of the anchor 830 of FIG. 27 according to an example configuration of the current disclosure. The anchor 830 can have first section 831 and a second section 832. A section 842 of a second tensile member 840 (e.g., the second section 246B of the second tensile member 246 of FIG. 17) can be coupled to the second section 832 of the anchor 830, and a stud 834 can be coupled to the first section 831 of the anchor 830. The stud 834 can have a stud body 835 and a stud head 836. The stud body 835 can be elongated between a stud first section 837 and a stud second section 838. The stud second section 838 can be coupled to the first section 831 of the anchor 830 and the stud head 836 can be formed on the stud first section 837. The stud body 835 can have a circular cross-section having a first radius 8351. The stud head 836 can also have a circular cross-section having a second radius 8361. The second radius 8361 can be larger than the first radius 8351. The stud 834 can have a stud axis 839. The stud body 835 and the stud head 836 can be concentric, and the stud axis 839 can be located at the center of concentricity.

FIG. 29 is a perspective view of the coupler mechanism 850 of FIG. 27 according to an example configuration of the current disclosure. The coupler mechanism 850 can have a rod 851 having a rod first portion 852 and a rod second portion 853. The rod 851 can be rotatably coupled to the fixed portion 810, and it can be configured to rotate relative to the fixed portion 810 around a rod axis 854. The rod 851 can be elongated along the rod axis 854 between the rod first portion 852 and the rod second portion 853.

A coupler plate 860 can be coupled to the rod 851 proximate the rod first portion 852. The coupler plate 860 can extend from the rod 851 in a radial direction (e.g., the rod axis 854 can be perpendicular to the coupler plate 860). The coupler plate 860 can be configured to rotate together with the rod 851 around the rod axis 854.

A keyhole 862 can be formed on the coupler plate 860. The keyhole 862 can be formed on a circular path 863. The center point of the circular path 863 can be located on the rod axis 854. The keyhole 862 can have an access hole 865 formed on one end, and a circular slot 866 can extend from the access hole 865 along a circular path 863. The access hole 865 can be a circular hole with a radius larger than the radius of the stud head 836 (e.g., larger than the second radius 8361). A width of the circular slot 866 can be slightly larger than the radius of the stud body 835 (e.g., larger than the first radius 8351) but smaller than the radius of the stud head 836 (e.g., smaller than the second radius 8361). In a high position of the movable portion 820 (e.g., the movable portion 820 can be proximate a second section 812, as illustrated in FIG. 27), the stud 834 can be at least partially located inside the keyhole 862.

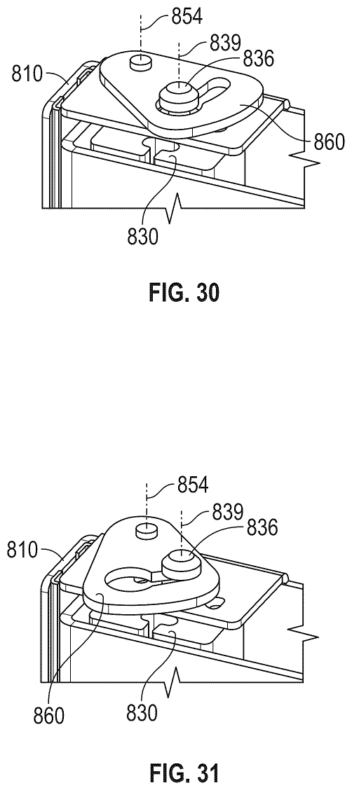

FIGS. 30-31 are partial perspective views of the lift mechanism 800 of FIG. 27 according to some example configurations of the current disclosure. In a high position of the movable portion 820, the coupler plate 860 can be configured to rotate in a counterclockwise direction around the rod axis 854 to put the coupler mechanism 850 in a decoupled configuration, as illustrated in FIG. 30. In the decoupled configuration, the stud head 836 can be concentric with the access hole 865 such that the stud head 836 (and thus, the anchor 830) can disengage from the coupler plate 860 and move in a direction parallel to the stud axis 839 when the movable portion 820 translates relative to the fixed portion 810. The decoupled configuration of the coupler mechanism 850 can correspond to a low force orientation of the lift mechanism 800.

In a high position of the movable portion 820, the coupler plate 860 can rotate in a clockwise direction around the rod axis 854 to put the coupler mechanism 850 in a coupled configuration, as illustrated in FIG. 31. In the coupled configuration, the stud body 835 can be at least partially located inside the circular slot 866, and the stud head 836 can be located above the coupler plate 860. In the coupled configuration, the stud 834 cannot disengage from the coupler plate 860, and thus, the anchor 830 can be coupled to the fixed portion 810 and cannot move with the movable portion 820 when the movable portion 820 translates relative to the fixed portion 810. The coupled configuration of the coupler mechanism 850 can correspond to a high force orientation of the lift mechanism 800.

In some example configurations, a foot 870 can be coupled to the rod 851 proximate the second portion 853. The foot 870 can extend from the rod 851 in a radial direction (e.g., the rod axis 854 can be perpendicular to the foot 870). The foot 870 can be configured to rotate with the rod 851 and the coupler plate 860 around the rod axis 854. The foot 870 can rotate towards the movable portion 820 when the rod 851 rotates in clockwise direction to put it in a coupled configuration. In some example configurations, the foot 870 can interfere with the movable portion 820 to limit its travel in the coupled configuration. The foot 870 can rotate away from the movable portion 820 to prevent any interference of the foot 870 with the movable portion 820 when the rod 851 rotates in the counterclockwise direction to put it in the decoupled configuration.

### ADDITIONAL NOTES AND EXAMPLES

Example 1 is a lift mechanism, comprising: a fixed portion extending between a first section and a second section, wherein the fixed portion is couplable to a structure; and a movable portion slidingly engaged with the fixed portion, wherein the movable portion is adapted to receive a component, and wherein the movable portion is configured to translate relative to the fixed portion within a range of travel including a high position and a low position to provide a height adjustment for the component.

In Example 2, the subject matter of Example 1 optionally includes a counterbalance mechanism operationally coupled between the fixed portion and the movable portion, wherein the counterbalance mechanism is configured to counter at least a portion of a combined weight of the component and the movable portion.

In Example 3, the subject matter of Example 2 optionally includes wherein the counterbalance mechanism comprises: one or more springs operably coupled to the first section of the fixed portion; a wheel assembly rotatably coupled to the fixed portion proximate the second section of the fixed portion, wherein the wheel assembly comprises: a wheel member; and a cam member coupled to the wheel member; wherein the cam member and the wheel member are concentric, and wherein the cam member and the wheel member are adapted to rotate in unison around a wheel axis, and one or more idler pulleys rotatably coupled to the fixed portion or the movable portion.

In Example 4, the subject matter of Example 3 optionally includes the counterbalance mechanism further comprising an adjustment assembly, wherein the adjustment assembly comprises: an adjustment screw rotatably coupled to the first section of the fixed portion; a first spring plate coupled to a first portion of the one or more springs, the first spring plate defining a threaded aperture proximate a center of the first spring plate; and a second spring plate coupled to a second portion of the one or more springs; wherein the first spring plate is threadedly engaged with the adjustment screw at the threaded aperture, wherein the first spring plate is configured to translate along a portion of the adjustment screw when the adjustment screw is rotated, and wherein the adjustment assembly is configured to adjust a tension of one or more springs when the adjustment screw is rotated.

In Example 5, the subject matter of Example 4 optionally includes a first tensile member coupled between the second spring plate and the cam member; and a second tensile member extending between a first section and a second section, the first section of the second tensile member coupled to the wheel member, routed around the one or more idler pulleys, the second section coupled to an anchor; wherein the first tensile member is configured to translate a first force generated by the one or more springs to the cam member, wherein the second tensile member is configured to translate a second force to the anchor, wherein the second force is defined through a torque balance over the wheel assembly, and wherein the second force is adapted to counter at least a portion of the combined weight of the component and the movable portion.

In Example 6, the subject matter of any one or more of Examples 3-5 optionally include wherein the one or more idler pulleys include: a first idler pulley coupled to the fixed portion; and a second idler pulley coupled to the movable portion.

In Example 7, the subject matter of any one or more of Examples 5-6 optionally include wherein the lift mechanism configured to include a high force orientation and a low force orientation, wherein the anchor is coupled to the fixed portion in the high force orientation and the anchor is coupled to the movable portion in the low force orientation.

In Example 8, the subject matter of Example 7 optionally includes wherein the lift mechanism also has a first fastener and a second fastener, wherein the first fastener is configured to engage with both the fixed portion and the anchor to put the lift mechanism in the high force orientation, and wherein the second fastener is configured to engage with both the movable portion and the anchor to put the lift mechanism in the low force orientation.

In Example 9, the subject matter of any one or more of Examples 1-8 optionally include wherein the lift mechanism further comprises one or more sliders coupled between the fixed portion and the movable portion, wherein the one or more sliders are configured to provide guidance for the movable portion during its translation between the high position and the low position.

Example 10 is a lift mechanism, comprising: a fixed portion extending between a first section and a second section; wherein the fixed portion is couplable to a structure, a movable portion slidingly engaged with the fixed portion; wherein the movable portion is adapted to receive a component, a counterbalance mechanism operably coupled between the fixed portion and the movable portion; a transition pulley assembly rotatably coupled to the fixed portion; wherein the transition pulley assembly includes a first transition pulley and a second transition pulley coupled to the first transition pulley, wherein the first transition pulley and the second transition pulley are adapted to rotate relative to the fixed portion in unison, and an idler pulley rotatably coupled to the movable portion; wherein the movable portion is configured to translate relative to the fixed portion within a range of travel including a high position proximate the first section of the fixed portion and a low position proximate the second section of the fixed portion, wherein the lift mechanism is configured to provide a height adjustment for the component between the high position and the low position, and wherein the counterbalance mechanism is configured to cooperate with the transition pulley assembly and the idler pulley to counter at least a portion of a combined weight of the component and the movable portion during the height adjustment.

In Example 11, the subject matter of Example 10 optionally includes wherein the counterbalance mechanism further comprises: one or more springs operably coupled to the first section of the fixed portion; a wheel assembly rotatably coupled to the fixed portion proximate the second section of the fixed portion; wherein the wheel assembly comprises a wheel member and a cam member coupled to the wheel member, wherein the cam member and the wheel member are concentric and they are adapted to rotate around a wheel axis in unison, a first tensile member coupled between the one or more springs and the cam member; wherein the first tensile member is configured to translate a spring force generated by the one or more springs to the cam member, a second tensile member extending between a first section and a second section, the first section of the second tensile member coupled to the wheel member and the second section coupled to the first transition pulley, wherein the second tensile member is configured to translate a first force to the first transition pulley, and a third tensile member extending between a first section and a second section, the first section of the third tensile member coupled to the second transition pulley, routed around the idler pulley, and the second section coupled to an anchor, wherein the third tensile member is configured to translate a second force to the anchor to counter at least a portion of the combined weight of the component and the movable portion.

In Example 12, the subject matter of Example 11 optionally includes wherein the first transition pulley has a first radius and the second transition pulley has a second radius different than the first radius, and wherein the transition pulley assembly is adapted to scale the first force by a ratio of the first radius to the second radius to create the second force.

In Example 13, the subject matter of any one or more of Examples 11-12 optionally include wherein the lift mechanism is configured to have a high force orientation and a low force orientation, and wherein the anchor is coupled to the fixed portion in the high force orientation and the anchor is coupled to the movable portion in the low force orientation.

In Example 14, the subject matter of any one or more of Examples 7-13 optionally include wherein the lift mechanism further comprises a coupler mechanism, and wherein the coupler mechanism is configured to selectably couple the anchor to the fixed portion to put the lift mechanism in the high force orientation or decouple the anchor from the fixed portion to put the lift mechanism in the low force orientation.

In Example 15, the subject matter of Example 14 optionally includes wherein the coupler mechanism comprises: a rod extending between a first section and a second section along a rod axis, and a coupler plate coupled to the rod proximate the first section of the rod; wherein the rod axis is perpendicular to the coupler plate, and wherein the coupler plate is configured to rotate relative to the fixed portion around the rod axis.

In Example 16, the subject matter of Example 15 optionally includes wherein the anchor extends between a first section and a second section, wherein the second section of the anchor is operably coupled to the counterbalance mechanism, and a stud having a stud body and a stud head is coupled to the first section, and wherein the stud body is formed in a circular cross-section having a first radius and the stud head is formed in a circular cross-section having a second radius larger than the first radius.

In Example 17, the subject matter of Example 16 optionally includes wherein the coupler plate includes a keyhole having an access hole and a slot extending from the access hole, wherein the slot extends from the access hole along a circular path to form the keyhole, wherein a width of the slot is smaller than a radius of the access hole, wherein a center of the circular path coincides with the rod axis, and wherein the access hole is adapted to receive the stud head and the slot is adapted to receive the stud body.

In Example 18, the subject matter of Example 17 optionally includes wherein the lift mechanism further includes a shelf coupled to the movable portion, wherein the shelf at least partially overlaps with the anchor, wherein the coupler plate configured to rotate in a first direction to align the access hole with the stud head in the low force orientation, wherein the stud head passes through the access hole to clear the coupler plate and the anchor is adapted to sit on the shelf such that the anchor is configured to translate with the movable portion in the low force orientation, wherein the coupler plate is configured to rotate in a second direction opposite the first direction to align the stud body with the slot in the high force orientation such that the stud body is at least partially located inside the slot and the stud head is located above the coupler plate, and wherein the coupler plate is adapted to trap the stud head and immobilize the anchor relative to the fixed portion during the translation of the movable portion in the high force orientation.

In Example 19, the subject matter of Example 18 optionally includes wherein the coupler mechanism further comprises a foot coupled to the rod proximate the second section of the rod, wherein the foot extends from the rod in a transverse direction, and wherein the foot is configured to interfere with the movable portion to limit its translation relative to the fixed portion when the coupler plate is rotated in the second direction to put the lift mechanism in the high force orientation.

Each of these non-limiting examples can stand on its own or can be combined in any permutation or combination with any one or more of the other examples.

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

1. A lift mechanism, comprising:
a fixed portion extending between a first section and a second section, wherein the fixed portion is couplable to a structure; and
a movable portion slidingly engaged with the fixed portion, wherein the movable portion is adapted to receive a component, and wherein the movable portion is configured to translate relative to the fixed portion within a range of travel including a high position and a low position to provide a height adjustment for the component, and.
a counterbalance mechanism including an anchor, wherein the counterbalance mechanism is operationally coupled between the fixed portion and the movable portion, wherein the counterbalance mechanism is configured to counter at least a portion of a combined weight of the component and the movable portion,
wherein the lift mechanism configured to include a high force orientation and a low force orientation; and
wherein the anchor is coupled to the fixed portion in the high force orientation and coupled to the movable portion in the low force orientation.

2. (canceled)

3. The lift mechanism of claim 1, wherein the counterbalance mechanism comprises:
one or more springs operably coupled to the first section of the fixed portion;
a wheel assembly rotatably coupled to the fixed portion proximate the second section of the fixed portion, wherein the wheel assembly comprises:
a wheel member; and
a cam member coupled to the wheel member;
wherein the cam member and the wheel member are concentric, and wherein the cam member and the wheel member are adapted to rotate in unison around a wheel axis, and
one or more idler pulleys rotatably coupled to the fixed portion or the movable portion.

4. The lift mechanism of claim 3, the counterbalance mechanism further comprising an adjustment assembly, wherein the adjustment assembly comprises:
an adjustment screw rotatably coupled to the first section of the fixed portion;
a first spring plate coupled to a first portion of the one or more springs, the first spring plate defining a threaded aperture proximate a center of the first spring plate; and
a second spring plate coupled to a second portion of the one or more springs;
wherein the first spring plate is threadedly engaged with the adjustment screw at the threaded aperture,
wherein the first spring plate is configured to translate along a portion of the adjustment screw when the adjustment screw is rotated, and
wherein the adjustment assembly is configured to adjust a tension of one or more springs when the adjustment screw is rotated.

5. The lift mechanism of claim 4, further comprises:
a first tensile member coupled between the second spring plate and the cam member; and
a second tensile member extending between a first section and a second section, the first section of the second tensile member coupled to the wheel member, routed around the one or more idler pulleys, the second section coupled to the anchor;
wherein the first tensile member is configured to translate a first force generated by the one or more springs to the cam member,
wherein the second tensile member is configured to translate a second force to the anchor, wherein the second force is defined through a torque balance over the wheel assembly, and
wherein the second force is adapted to counter at least a portion of the combined weight of the component and the movable portion.

6. The lift mechanism of claim 3, wherein the one or more idler pulleys include:
a first idler pulley coupled to the fixed portion; and
a second idler pulley coupled to the movable portion.

7. (canceled)

8. The lift mechanism of claim 5, wherein the lift mechanism also has a first fastener and a second fastener,
wherein the first fastener is configured to engage with both the fixed portion and the anchor to put the lift mechanism in the high force orientation, and
wherein the second fastener is configured to engage with both the movable portion and the anchor to put the lift mechanism in the low force orientation.

9. The lift mechanism of claim 1, wherein the lift mechanism further comprises one or more sliders coupled between the fixed portion and the movable portion,
wherein the one or more sliders are configured to provide guidance for the movable portion during its translation between the high position and the low position.

10. A lift mechanism, comprising:
a fixed portion extending between a first section and a second section; wherein the fixed portion is couplable to a structure,
a movable portion slidingly engaged with the fixed portion; wherein the movable portion is adapted to receive a component,
a counterbalance mechanism operably coupled between the fixed portion and the movable portion;
a transition pulley assembly rotatably coupled to the fixed portion; wherein the transition pulley assembly includes a first transition pulley and a second transition pulley coupled to the first transition pulley, wherein the first transition pulley and the second transition pulley are adapted to rotate relative to the fixed portion in unison, and
an idler pulley rotatably coupled to the movable portion;
wherein the movable portion is configured to translate relative to the fixed portion within a range of travel including a high position proximate the first section of the fixed portion and a low position proximate the second section of the fixed portion,
wherein the lift mechanism is configured to provide a height adjustment for the component between the high position and the low position, and
wherein the counterbalance mechanism is configured to cooperate with the transition pulley assembly and the idler pulley to counter at least a portion of a combined weight of the component and the movable portion during the height adjustment.

11. The lift mechanism of claim 10, wherein the counterbalance mechanism further comprises:
one or more springs operably coupled to the first section of the fixed portion;
a wheel assembly rotatably coupled to the fixed portion proximate the second section of the fixed portion; wherein the wheel assembly comprises a wheel member and a cam member coupled to the wheel member, wherein the cam member and the wheel member are concentric and they are adapted to rotate around a wheel axis in unison,
a first tensile member coupled between the one or more springs and the cam member; wherein the first tensile member is configured to translate a spring force generated by the one or more springs to the cam member,
a second tensile member extending between a first section and a second section, the first section of the second tensile member coupled to the wheel member and the second section coupled to the first transition pulley, wherein the second tensile member is configured to translate a first force to the first transition pulley, and a third tensile member extending between a first section and a second section, the first section of the third tensile member coupled to the second transition pulley, routed around the idler pulley, and the second section coupled to an anchor, wherein the third tensile member is configured to translate a second force to the anchor to counter at least a portion of the combined weight of the component and the movable portion.

12. The lift mechanism of claim 11, wherein the first transition pulley has a first radius and the second transition pulley has a second radius different than the first radius, and
wherein the transition pulley assembly is adapted to scale the first force by a ratio of the first radius to the second radius to create the second force.

13. The lift mechanism of claim 11, wherein the lift mechanism is configured to have a high force orientation and a low force orientation, and wherein the anchor is coupled to the fixed portion in the high force orientation and the anchor is coupled to the movable portion in the low force orientation.

14. The lift mechanism of claim 13, wherein the lift mechanism further comprises a coupler mechanism, and wherein the coupler mechanism is configured to selectably couple the anchor to the fixed portion to put the lift mechanism in the high force orientation or decouple the anchor from the fixed portion to put the lift mechanism in the low force orientation.

15. The lift mechanism of claim 14, wherein the coupler mechanism comprises:
a rod extending between a first section and a second section along a rod axis, and
a coupler plate coupled to the rod proximate the first section of the rod; wherein the rod axis is perpendicular to the coupler plate, and
wherein the coupler plate is configured to rotate relative to the fixed portion around the rod axis.

16. The lift mechanism of claim 15, wherein the anchor extends between a first section and a second section,
wherein the second section of the anchor is operably coupled to the counterbalance mechanism, and a stud having a stud body and a stud head is coupled to the first section, and
wherein the stud body is formed in a circular cross-section having a first radius and the stud head is formed in a circular cross-section having a second radius larger than the first radius.

17. The lift mechanism of claim 16, wherein the coupler plate includes a keyhole having an access hole and a slot extending from the access hole,
wherein the slot extends from the access hole along a circular path to form the keyhole,
wherein a width of the slot is smaller than a radius of the access hole,
wherein a center of the circular path coincides with the rod axis, and
wherein the access hole is adapted to receive the stud head and the slot is adapted to receive the stud body.

18. The lift mechanism of claim 17, wherein the lift mechanism further includes a shelf coupled to the movable portion, wherein the shelf at least partially overlaps with the anchor,
wherein the coupler plate configured to rotate in a first direction to align the access hole with the stud head in the low force orientation,
wherein the stud head passes through the access hole to clear the coupler plate and the anchor is adapted to sit on the shelf such that the anchor is configured to translate with the movable portion in the low force orientation,
wherein the coupler plate is configured to rotate in a second direction opposite the first direction to align the stud body with the slot in the high force orientation such that the stud body is at least partially located inside the slot and the stud head is located above the coupler plate, and
wherein the coupler plate is adapted to trap the stud head and immobilize the anchor relative to the fixed portion during the translation of the movable portion in the high force orientation.

19. The lift mechanism of claim 18, wherein the coupler mechanism further comprises a foot coupled to the rod proximate the second section of the rod,
wherein the foot extends from the rod in a transverse direction, and wherein the foot is configured to interfere with the movable portion to limit its translation relative to the fixed portion when the coupler plate is rotated in the second direction to put the lift mechanism in the high force orientation.

20. The lift mechanism of claim 19, wherein the foot is configured to interfere with the movable portion to limit its translation relative to the fixed portion when the coupler plate is rotated in the second direction to put the lift mechanism in the high force orientation.
